(19) United States
(12) Patent Application Publication
(10) Pub. No.: US 2024/0419230 A1
(43) Pub. Date: Dec. 19, 2024

(54) Data Center Power Management System

(71) Applicant: Crusoe Energy Systems LLC, Denver, CO (US)

(72) Inventors: Phillip Archer, Fraser, CO (US); Andrew Likens, Denver, CO (US); Garrett Rood, Lakewood, CO (US); Kenneth Parker, Denver, CO (US); Jeff Balkanski, San Francisco, CA (US); Anna Landler, San Francisco, CA (US); William Leins Stube, II, Denver, CO (US); David Edwards, Milford, NY (US)

(21) Appl. No.: 18/743,984

(22) Filed: Jun. 14, 2024

Related U.S. Application Data
(60) Provisional application No. 63/553,619, filed on Feb. 14, 2024.
(60) Provisional application No. 63/521,082, filed on Jun. 14, 2023.

(51) Int. Cl. G06F 1/26; G06F 1/28

(52) U.S. Cl. CPC G06F 1/263; G06F 1/28

(57) ABSTRACT

A power management system is provided for powering a primary group of power consumers and a secondary group of power consumers. The primary group of power consumers include a data center including a plurality of first computing units. The secondary group of power consumers include a plurality of second computing units whose power consumption is adjustable to ensure the first computing units are continuously powered. The first computing units are in communication with a network for providing cloud services to remote client computers. The first computing units have an energy priority over the second computing units. The power management system includes power sources including a first power source and a second power source. The second power source is a power generation module configured to consume natural gas and continuously generate an electrical output sufficient to alternatively power the plurality of first computing units and the second computing units. The power management system also includes a monitoring and control system configured to receive status inputs including an operational status and/or an operational cost of each of the power sources, and power consumption metrics of the primary group of power consumers and/or the secondary group of power consumers. The monitoring and control system is also configured to output a control signal to decrease a power consumption by the secondary group of power consumers and to power the primary group of power consumers by the second power source as a function of the operational status and/or operational cost of each of the power sources.

### CROSS-REFERENCE TO RELATED APPLICATIONS

The present application claims benefit of U.S. provisional patent application No. 63/521,082, titled “Data Center Power Management System,” filed Jun. 14, 2023 and U.S. provisional patent application No. 63/553,619, titled “System and Method for Dynamic Balancing of Power Production and Consumption,” filed Feb. 14, 2024, both of which are incorporated by reference herein in their entireties.

### BACKGROUND

U.S. Pat. No. 10,862,307, incorporated by reference herein in its entirety, discloses using power generation modules to convert a fuel gas stream into electricity, which may be employed to power any number of modular distributed computing units.

Power demand is spiking around the world due to increased use of power intensive computing resources such as cloud computing services, cryptocurrency mining and artificial intelligence, placing increasing demands on the electricity grid. To tackle the demand, it is essential to scale power and data center infrastructure

In the US market alone, data center demand is expected to reach 38 gigawatts (GW) by 2030, up from 17 GW in 2022. Studies from the U.S. Dept. of Energy, MIT, and Princeton have found the country must double or triple current transmission capacity by 2035 to meet growing demand with renewables at scale.

Systems and methods are thus needed to supply electricity to these power intensive computing resources, without increasing the demands on the electricity grid. Further, such systems and methods should limit carbon emissions, be configured for integration with renewable power sources, and provide flexibility to monetize underutilized power generation capacity as a function of the variable power demand of the computing resources.

### SUMMARY

A power management system is provided for powering a primary group of power consumers and a secondary group of power consumers. The primary group of power consumers include a data center including a plurality of first computing units. The secondary group of power consumers include a plurality of second computing units whose power consumption is adjustable to ensure the first computing units are continuously powered. The first computing units are in communication with a network for providing cloud services to remote client computers. The first computing units have an energy priority over the second computing units. The power management system includes power sources including a first power source and a second power source. The second power source is a power generation module configured to consume natural gas and continuously generate an electrical output sufficient to alternatively power the plurality of first computing units and the second computing units. The power management system also includes a monitoring and control system configured to receive status inputs including an operational status and/or an operational cost of each of the power sources, and power consumption metrics of the primary group of power consumers and/or the secondary group of power consumers. The monitoring and control system is also configured to output a control signal to decrease a power consumption by the secondary group of power consumers and to power the primary group of power consumers by the second power source as a function of the operational status and/or operational cost of each of the power sources.

In examples, the first power source is an electricity grid for powering the primary group of power consumers, the power management system further including: a power switching system configured to alternatively supply electricity from the first power source or the second power source to the computing units, the monitoring and control system configured to: receive status inputs including: an operational status of the electricity grid indicating an availability of electricity from the electricity grid to power the data center; and an operational cost of the electricity grid indicating a price of electricity from the electricity grid; and output a control signal to the power switching system to switch from the first power source to the second power source to supply electricity to the computing units based on the status inputs, at least some of the electricity generated by the second power source being redirected from the secondary group of power consumers to the first group of power consumers in response to the control signal.

In examples, the first power source is an electricity grid for powering the primary group of power consumers, the power management system further including: a third power source, the third power source being a renewable energy source, a power switching system configured to alternatively supply electricity from the first power source, the second power source or the third power source to the computing units, the monitoring and control system configured to: receive status inputs including: an operational status of each of the first power source and the third power source indicating an availability of electricity from each of the first power source and the third power source to power the data center; and an operational cost of each of the first power source and the third power source indicating a price of electricity from each of first power source and the third power source; and output a control signal to the power switching system to switch from the first power source and/or the third power source to the second power source to supply electricity to the computing units based on the status inputs, at least some of the electricity generated by the second power source being redirected from the secondary group of power consumers to the first group of power consumers in response to the control signal.

In examples, the power management system further includes a carbon capture system configured to receive exhaust gas from the second power source, capture carbon from the exhaust gas and release oxygen from the exhaust gas into the atmosphere.

In examples, the carbon capture system captures at least about 75% of the carbon from the exhaust gas.

In examples, the secondary group of power consumers are cryptocurrency miners and the status inputs include a revenue generated by the cryptocurrency miners per unit of electrical energy.

In examples, the status inputs include a price of natural gas per unit and power generated per unit of natural gas by the electrical power generation system.

In examples, the revenue generated by the cryptocurrency miners per unit of electrical energy is a function of a current market price of the cryptocurrency, a mining difficulty associated with the cryptocurrency, an average hash rate of the cryptocurrency miners, and/or a power consumption of the cryptocurrency miners.

In examples, the secondary group of power consumers are cryptocurrency miners and the monitoring and control system is configured to output a control signal to the power switching system to switch from the first power source and/or the third power source to the second power source to supply electricity to the computing units when a price of electricity from a least expensive of the first power source and the third power source is greater than a threshold power price derived from a value of the cryptocurrency with respect to a government currency, a hashrate of the cryptocurrency miners and a cost to operate the cryptocurrency miners.

In examples, the cost to operate the cryptocurrency miners includes a cost of thermal management for the cryptocurrency miners.

In examples, the second power source has a power output at least as great as a maximum power consumed by the data center.

In examples, the secondary group of power consumers are cryptocurrency miners and the monitoring and control system is configured to, in a first condition, direct the power switching system to cause the second power source to power the cryptocurrency miners and to cause the first power source to power the data center.

In examples, the power management system further includes a power switching system configured to supply electricity to the first computing units from the first power source or the second power source, wherein the monitoring and control system is configured to, in a second condition, direct the power switching system to electrically decouple the second power source from the cryptocurrency miners, to electrically decouple the first power source from the data center, and to direct the second power source to power the data center.

In examples, the monitoring and control system is configured to, in a third condition, direct the power switching system to electrically decouple the second power source from the cryptocurrency miners, to electrically decouple the first power source from the data center, and to direct the second power source to power the data center and to provide power to the first power source.

In examples, the power management system further includes a power switching system configured to supply electricity to the first computing units from the first power source or the second power source, wherein the secondary group of power consumers are cryptocurrency miners and the monitoring and control system is configured to direct the power switching system to maximize a total profit equal to a net profit of operating the data center plus a net profit of operating the cryptocurrency miners, and is configured to direct the power switching system to shut down the cryptocurrency miners and to power the data center by the second power source when doing so maximizes the total profit.

In examples, the first computing units each have a maximum power consumption, the first computing units together having a rated power consumption defined by a cumulative sum of maximum power consumptions of the first computing units, the first power source being power generation module configured to consume natural gas and continuously generate an electrical output to power the first computing units and the second computing units; the power management system further including: a power distribution system configured to distribute the electrical output generated by the first and second power sources to the first computing units and the second computing units; and a carbon capture system configured to receive exhaust gas from the first and second power sources, capture carbon from the exhaust gas and release oxygen from the exhaust gas into the atmosphere; the monitoring and control system being configured to: receive metrics of the first and second power sources; receive real-time power consumption metrics for the first computing units, the first computing units configured for consuming variable power during operation; and output a control signal to vary a power consumption of the second computing units based on a difference between the real-time power consumption metrics for the first computing units and the rated power consumption of the first computing units.

In examples, the power distribution system includes a common electrical bus syncing outputs of the first and second power sources to provide a common electrical output, the monitoring and control system configured to: control power consumed by the set of second computing units to achieve a predetermined electrical consumption of the common electrical output, the predetermined electrical consumption being a minimum threshold required by the carbon capture system.

In examples, the second computing units are cryptocurrency miners, the cryptocurrency miners each having a respective rated power consumption defining a maximum amount of power the cryptocurrency miner is designed to consume, the varying of the power consumption of the set of second computing units including increasing the power consumption of at least some of the cryptocurrency miners above the respective rated power consumption.

In examples, the second computing units are cryptocurrency miners, the second computing units including a subset of first cryptocurrency miners and a subset of second cryptocurrency miners, the varying of the power consumption of the set of second computing units including turning on and off the subset of second cryptocurrency miners.

In examples, the monitoring and control system is configured to: refrain from varying the power consumption of the subset of first cryptocurrency miners while turning on and off the subset of second cryptocurrency miners.

In examples, the first cryptocurrency miners have a higher average hashrate per unit of energy consumed than the second cryptocurrency miners.

In examples, the power management system further includes a heating, ventilation and air conditioning (HVAC) system configured to consume the electrical output generated by the first power source and/or the second power source, the monitoring and control system configured to: receive metrics of the HVAC system; and output the control signal to vary the power consumption of the set of second computing units based on: the difference between the real-time power consumption metrics for the set of first computing units and the rated power consumption of the set of first computing units; and real-time power consumption metrics for the HVAC system.

A method of dynamically controlling a supply of power to a power consumption system powered by a power production system is also provided. The method includes the following steps: measuring and/or receiving metrics of the power production system while powering the power consumption system, the power consumption system including a plurality of computing units including at least a set of first computing units and a set of second computing units, the first computing units in communication with a network for providing cloud services to remote client computers, the first computing units having an energy priority over the second computing units, the power production system including power sources including a first power source and a second power source, the second power source including a power generation module configured to consume natural gas and continuously generate an electrical output sufficient to alternatively power the plurality of first computing units and the second computing units; determining, from the metrics of the power production system, an operational status and/or an operational cost of each of the power sources; and decreasing a power consumption of the second computing units and powering the set of first computing units by the second power source based on the operational status and/or the operational cost of each of the power sources.

A method of controlling a power consumption of a power consumption system powered by a power production system is also provided. The method includes the following steps: (a) measuring and/or receiving metrics of the power production system and metrics of a power consumption system, the power consumption system including a plurality of computing units including at least a set of first computing units and a set of second computing units, the first computing units in communication with a network for providing cloud services to remote client computers, the first computing units having an energy priority over the second computing units, the first computing units each having a maximum power consumption, the set of first computing units together having a rated power consumption defined by a cumulative sum of the maximum power consumptions of the first computing units; (b) determining a target power production framework that includes a target power delta for each of a plurality of devices associated with the power production system, the target power deltas being based on the metrics of power production system; (c) determining an optimal power consumption distribution model for distributing the target power deltas of the target power production framework to the power consumption system based on the target power production framework and the metrics of power consumption system, the optimal power consumption distribution model taking into account a varying power consumption of the first computing units to vary a power consumption of the second computing units; (d) altering a power state of the second computing units to achieve the optimal power consumption distribution model; and periodically repeating (a) to (d) to update the power state of the second computing units based on changes of the metrics of the power production system and changes of metrics of the power consumption system.

In examples, the second computing units are cryptocurrency miners, the cryptocurrency miners each having a respective rated power consumption defining a maximum amount of power the cryptocurrency miner is designed to consume, the altering a power state of the second computing units including increasing the power consumption of at least some of the cryptocurrency miners above the respective rated power consumption.

In examples, the second computing units are cryptocurrency miners, the second computing units including a subset of first cryptocurrency miners and a subset of second cryptocurrency miners, the altering a power state of the second computing units including turning on and off the subset of second cryptocurrency miners.

In examples, the determining an optimal power consumption distribution model includes distributing the target power deltas of the target power production framework to the power consumption system to achieve a power production of the power production system above a predetermined threshold.

In examples, the power production system includes a power generation module configured to consume natural gas and continuously generate an electrical output sufficient to alternatively power the plurality of first computing units and the second computing units the predetermined threshold being a function of a cost of operating a carbon capture system configured to receive exhaust gas from the electrical power generation system, capture carbon from the exhaust gas and release oxygen from the exhaust gas into the atmosphere.

In examples, the determining an optimal power consumption distribution model includes distributing the target power deltas of the target power production framework to the power consumption system to maximize a power production of the power production system.

A method for powering a data center including a plurality of computing units and a cryptocurrency mining system including a plurality of cryptocurrency miners is also provided. The method includes powering the data center by power generated from one or more primary power sources, the primary power sources including a renewable energy source and an electricity grid; powering the cryptocurrency mining system by an electrical power generation system including one or more power generation modules configured to consume natural gas and continuously generate an electrical output; and upon determining that the power generated from the one or more primary power sources costs a price exceeding a predetermined price threshold, electrically decoupling the electrical power generation system from the cryptocurrency miners and electrically decoupling the one or more primary power sources from the data center, and powering the data center by the electrical power generation system.

A method for powering a data center including a plurality of computing units and a cryptocurrency mining system including a plurality of cryptocurrency miners is also provided. The method includes powering the data center by power generated from one or more primary power sources, the primary power sources including a renewable energy source and an electricity grid; powering the cryptocurrency mining system by an electrical power generation system including one or more power generation modules configured to consume natural gas and continuously generate an electrical output; and upon determining that the power generated from the one or more primary power sources costs a price exceeding a predetermined price threshold, electrically decoupling the electrical power generation system from the cryptocurrency miners and electrically decoupling the one or more primary power sources from the data center, and powering the data center by the electrical power generation system and selling excess power generated by the electrical power generation system to the electrical grid.

### BRIEF DESCRIPTION OF THE DRAWINGS

The present disclosure is described below by reference to the following drawings, in which:

FIG. 1 shows an exemplary power management system 100 according to an embodiment.

FIG. 2 shows a first embodiment of the exemplary power management system.

FIG. 3 shows the exemplary power management system of FIG. 2 illustrating the power production system in a first condition.

FIG. 4 shows the exemplary power management system of FIG. 2 in a second condition.

FIG. 5 shows the exemplary power management system of FIG. 2 in a third condition.

FIG. 6 shows an exemplary electrical power generation system 600 according to an embodiment.

FIG. 7 shows a first exemplary power production system configured for achieving the conditions of FIGS. 3 to 5.

FIG. 8 shows a second exemplary power production system 800 configured for achieving the conditions of FIGS. 3 to 5.

FIG. 9 shows a third exemplary power production system 900 configured for achieving the conditions of FIGS. 3 to 5.

FIG. 10 shows an exemplary power production system 1000 configured for achieving the configuration of FIG. 11.

FIG. 11 shows a power management system 1100 including power consumption system 1103 and a power production system 1105.

FIG. 12 shows a graphical illustration of power usable by an exemplary data center according to an embodiment.

FIG. 13a illustrates a power control method 1300 of dynamically controlling a supply of power in the system of FIG. 11.

FIG. 13b illustrates substeps of step 1306 of the method of FIG. 13a.

FIG. 14 schematically shows a simplified power consumption distribution model 1400 and helps to illustrate the substeps of step 1306 of the method of FIG. 13a.

FIG. 15 shows an exemplary data center system 1500 according to an embodiment.

FIG. 16 shows an exemplary cryptocurrency mining system 1600 according to an embodiment.

FIG. 17 shows an exemplary computing machine 1700 and modules 1750 according to an embodiment.

### DETAILED DESCRIPTION

### System Overview

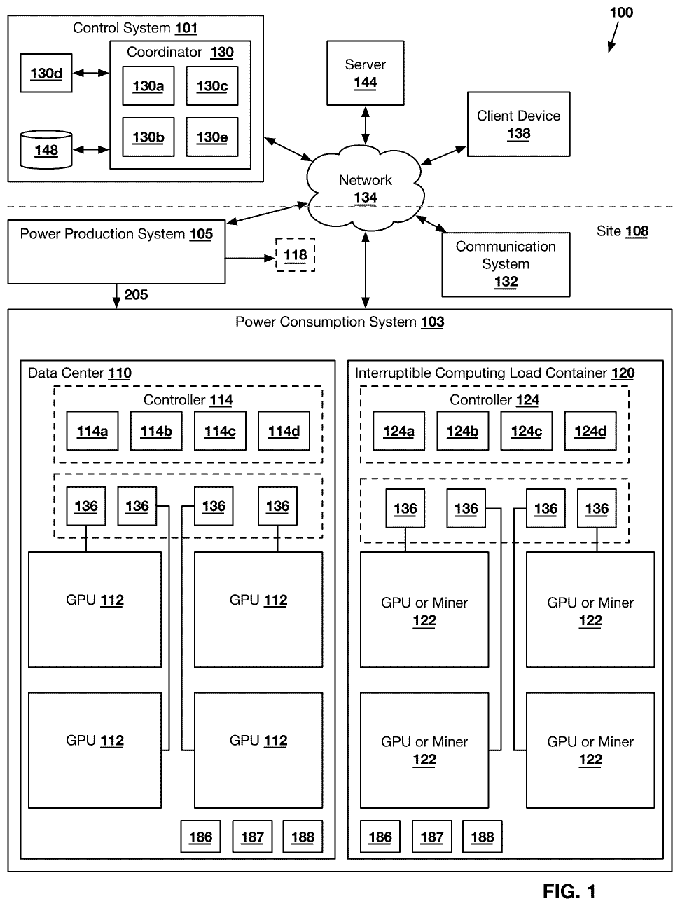

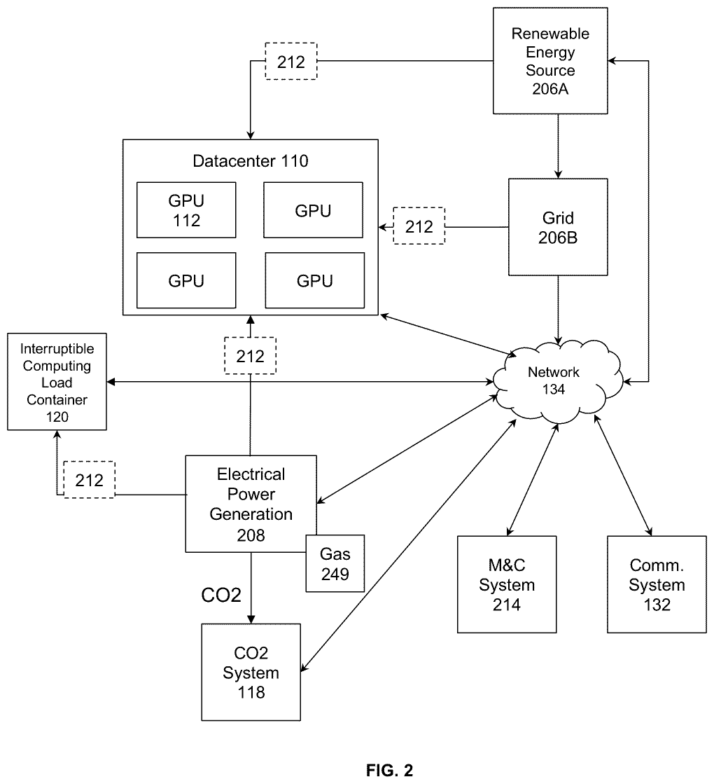

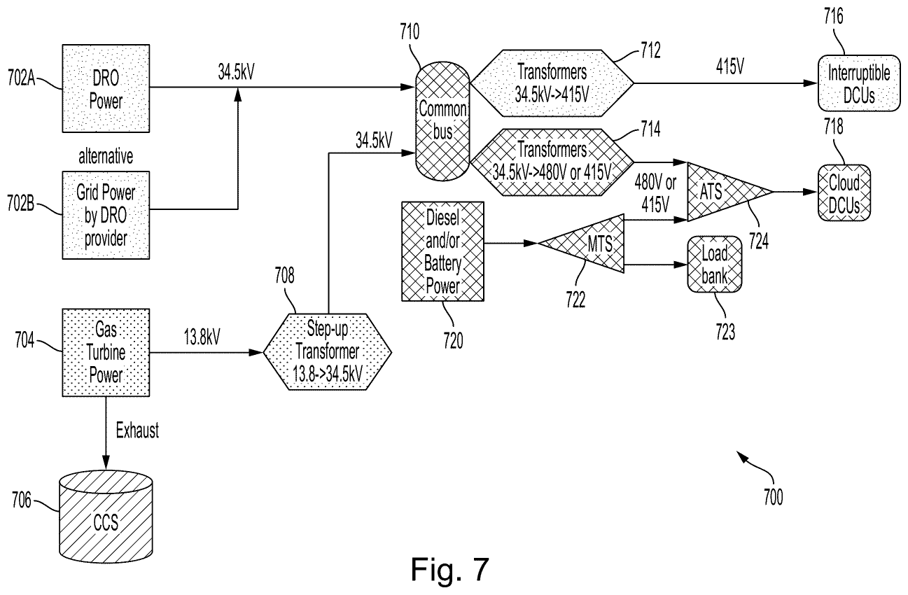

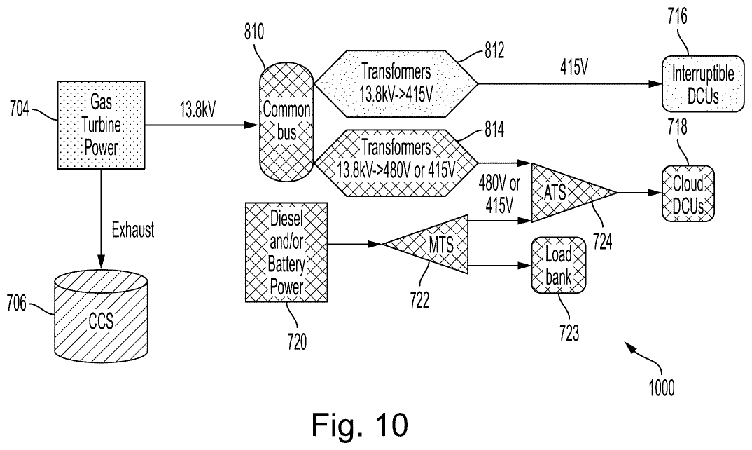

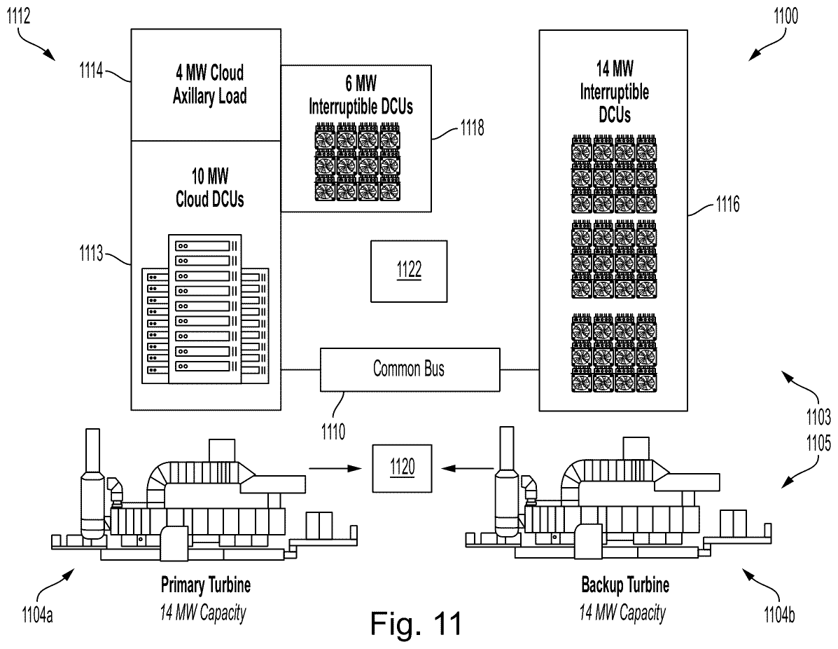

Referring to FIG. 1, an exemplary power management system 100 is illustrated. As shown, the system 100 may comprise a power consumption system 103 and a power production system 105. Details of the power production system 105 are further illustrated in a first embodiment of the power production system shown generally in FIG. 2, and more specifically in examples thereof in FIGS. 7 to 9, and in a second embodiment of the power production system shown generally in FIG. 11, and more specifically in an example thereof in FIG. 10.

Power consumption system 103 includes a primary group of power consumers in the form of at least one data center 110 and a secondary group of power consumers in the form of an interruptible computing load container 120. Data center 110 can include a plurality of distributed computing units (DCUs), including, for example, GPUs and/or CPUs 112 for providing cloud computing services to remote client computers. The interruptible computing loads container 120 can include interruptible computing load in the form of DCUs including, for example, further GPUs and/or CPUs and/or cryptocurrency miners 122 that can be powered off or down based on power demands.

The power production system 105 can include at least two power sources to provide redundancy, allowing data center 110 to be powered in the event one of the power sources is turned off and/or to adjust the supply of power to optimize revenue generation for the operator of power management system 100. The DCUs 112 of interruptible computing load container 120 can be powered off or powered down in the event one of the power sources is turned off.

As further described below, the power management system 100 can also include a monitoring and control system 214 (FIG. 2) including control system 101, and container controllers 114, 124.

The power management system 100 can further include, along with other components described further below, an optional carbon capture system 118 to receive exhaust gas from at least one of the power sources and capture carbon from the exhaust gas. In certain embodiments, the carbon capture system may further release oxygen into the atmosphere.

The power management system 100 of the present disclosure can advantageously provide power production redundancy that is instantaneously available for computing units providing cloud services to remote client computers (e.g., via server 144), without wasting power that is produced, by powering revenue-generating power consumers (i.e., DCUs 122 in interruptible computing load container 120) whose power production can be turned off immediately.

To achieve these goals, the power production system 105 is configured for powering the primary group of power consumers (e.g., data center 110) and the secondary group of power consumers (e.g., interruptible computing load container 120). The primary group of power consumers can include the data center 110 including the plurality of first computing units (e.g., GPUs 112). The secondary group of power consumers can include the plurality of second computing units (e.g., further GPUs and/or cryptocurrency miners 122) whose power consumption is adjustable to ensure the first computing units 112 are continuously powered. Each of the first computing units 112 is in communication with a network 134 for providing cloud services to remote client computers, and the first computing units 112 have an energy priority over the second computing units 122.

It will be appreciated that network 134 may comprise one or more local networks. As an example, first computing units 112 may each be in communication with a first local network, while power management and other system components may be in communication with a separate, second local network. In other embodiments, subsets of computing units may each be in communication with separate local networks (e.g., segregated by cloud services customer). In addition to the one or more local networks, network 134 comprises a wide area network to allow for remote access to the various system components discussed herein.

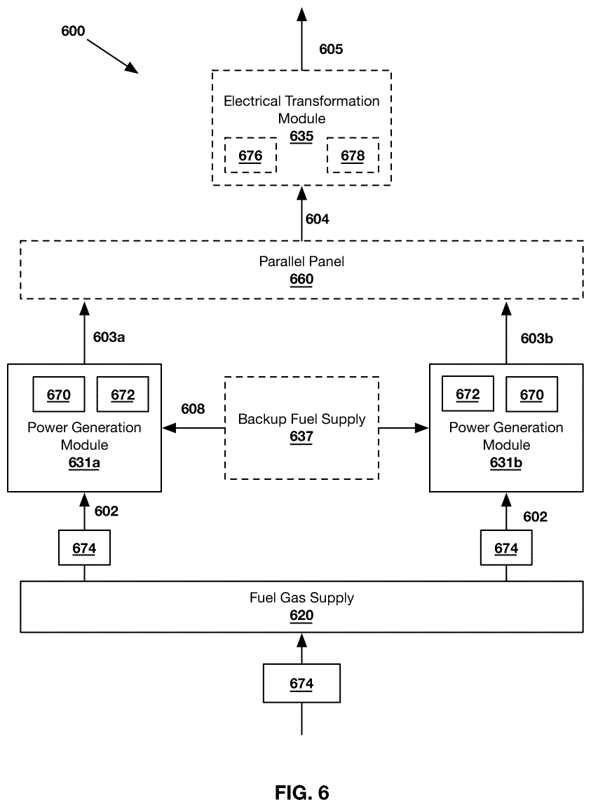

In certain embodiments, a power management system can include power sources including a first power source (e.g., power source 206A, 206B in FIG. 2 or power source 1104a in FIG. 11) and a second power source (e.g., electrical power generation system 208 in FIG. 2 or power source 1104b in FIG. 11). The second power source 208 can be a power generation module (e.g., 631 in FIG. 6) configured to consume a fuel gas (e.g., natural gas) and continuously generate an electrical output sufficient to alternatively power the plurality of first computing units 112 and the second computing units 122.

Exemplary power management systems 100 can also include a monitoring and control system 214 configured to receive status inputs including an operational status and/or an operational cost of each of the power sources; and power consumption metrics of the primary group of power consumers and/or the secondary group of power consumers. Monitoring and control system 214 may also be configured to output a control signal to decrease a power consumption by the secondary group of power consumers and to power the primary group of power consumers by the second power source as a function of the operational status and/or operational cost of each of the power sources. The operational status can be determined by the monitoring and control system 214 in the manner described with respect to step 1304 in method 1300, or the monitoring and control system 214 can receive an input indicating a planned or unplanned power outage. The operational cost can be the price per unit power of each power source received or determined by the monitoring and control system 214.

### Power Consumption System

The power consumption system 103 generally comprises any number of power consumers, including DCUs 112, 122, adapted to consume the electrical power provided by the power production system 105. In one embodiment, DCUs 112 can comprise CPUs and/or GPUs for providing cloud services, and DCUs 122 can be CPUs and/or GPUs for providing cloud services and/or cryptocurrency miners. Preferably, the DCUs 112, 122 collectively enable a modular computing installation, for example, a data center, cryptocurrency mine or graphics computing cell.

Each of the DCUs 112, 122 may comprise a computing machine having one or more processors (e.g., CPUs, GPUs, ASICs, etc.) adapted to conduct any number of processing-, computational-, and/or graphics-intensive computing processes. For example, the DCUs may be employed for artificial intelligence (“AI”) research, training machine learning (“ML”) and other models, data analysis, server functions, storage, virtual reality (“VR”) and/or augmented reality (“AR”) applications, tasks relating to the Golem Project, non-currency blockchain applications. Additionally or alternatively, the DCUs 112 may be adapted to execute mathematical operations in relation to training computationally intensive machine learning, artificial intelligence, statistical or deep learning models, such as neural networks, recurrent neural networks, convolutional neural networks, generative adversarial networks, gradient boosting machines, random forests, classification and regression trees, linear, polynomial, exponential and generalized linear regressions, logistic regression, reinforcement learning, deep reinforcement learning, hyperparameter optimization, cross validation, support vector machines, principal component analysis, singular value decomposition, convex optimization, and/or independent component analysis. In one particular embodiment, the DCUs 112 may comprise GPUs.

In some embodiments, the DCUs 122 of the secondary group of power consumers may include a plurality of cryptocurrency miners adapted to execute mathematical operations in relation to the mining of cryptocurrencies. In one preferred embodiment the miners may comprise ASICs configured to execute the SHA-256 hashing algorithm to mine Bitcoin. In other embodiments, the cryptocurrency miners may be configured to compute any of the following hashing algorithms: scrypt, CryptoNight, RIPEMD160, BLAKE256, X11, Dagger-Hashimoto, Equihash, LBRY, X13, NXT, Lyra2RE, Qubit, Skein, Groestl, BOINC, X11gost, Scrypt-jane, Quark, Keccak, Scrypt-OG, X14, Axiom, Momentum, SHA-512, Yescrypt, Scrypt-N, Cunningham, NIST5, Fresh, AES, 2Skein, Equilhash, KSHAKE320, Sidechain, Lyra2RE, HybridScryptHash256, Momentum, HEFTY1, Skein-SHA2, Qubit, SpreadX11, Pluck, and/or Fugue256.

The DCUs 112, 122 may be housed within one or more containers, structures, or data centers disposed at a physical location associated with a site 108. In some embodiments, the containers may comprise a prefabricated housing or enclosure to contain and protect the various electronics disposed therein. Generally, the enclosure(s) may define an interior space for the DCUs 112, 122 and controllers 114, 124. In one embodiment, the enclosure(s) may comprise a customized shipping container or other modular housing system designed for portability, durability, safety, stack-ability, ventilation, weatherproofing, dust control and operation in rugged oilfield conditions. In other embodiments, the enclosure(s) may comprise a permanent or semi-permanent structure.

Each container may also include an electrical power distribution system 186 adapted to receive electrical power 205 from the power production system 105 and distribute the same to the various electrical components of the system. To that end, the power distribution system 186 may comprise a series of power distribution units (“PDUs”) or power channels in communication with one or more breaker panels. In some embodiments the containers may include, or otherwise be placed in communication with, one or more backup power systems 187 (e.g., batteries, additional generators, etc.), and/or an environment control system 188.

In some examples, the power consumers can include other power consumers inside or outside of the containers. For example, power consumers may comprise pumps, lighting equipment, computer networking equipment, control systems, and/or oil production equipment.

As shown, the containers forming data center 110 and interruptible computing load container 120 (and any electronic components contained therein) include devices in communication with the central control system 101 via a connection to the communication system 132. For example, each container 110, 120 may include a plurality of network interfaces 136 of communication system 132 (each having a network address) and the DCUs 112, 122 may be connected to such interfaces 136 (e.g., via ethernet).

### Power Production System

As illustrated by the different embodiments in FIGS. 2 to 5 and 7 to 11, power production system 105 may include one or more primary power sources for powering the data center 110. The one or more primary power sources can include a renewable energy source 206A, and/or an electricity grid 206B, and/or an electrical power generation system 208. The renewable energy source 206A may comprise a behind-the-meter (“BTM”) power source, such as a wind farm including a plurality of wind turbines or a solar farm including a plurality of solar panels.

The power management system 100 further includes one or more secondary power sources for powering the data center 110 when the primary power sources are inoperable or when the cost of electricity provided by the primary power source(s) is greater than a threshold price. The one or more secondary power sources can be in the form of the electrical power generation system 208, which generally comprises any number of power generation modules adapted to consume a fuel gas (e.g., natural gas 249) to generate electrical power. The electrical power generation system 208 can be supplied by a natural gas pipeline in order to generate continuous power to alternatively power the power consumers of data center 110 or interruptible computing load container 120. To that end, the electrical power generation system 208 may be configured to output at least as much power as a maximum power required by the data center 110.

The electrical power generation system 208 can be, for example, the electrical power generation system 600 illustrated in FIG. 6. As shown in FIG. 6, each of the one or more power generation modules 631a, 631b of the electrical power generation system 208 may be adapted to generate an electrical output via combustion of a fuel gas 602. Generally, the power generation modules may employ either a gas-driven reciprocating engine or a gas-driven rotating turbine to combust the fuel gas and drive an electrical generator.

As shown in FIG. 6, the electrical power generation system 208 may include a fuel gas compressor 674 to compress the gas 602 before it is introduced to a power generation module 631a, 631b.

Referring to FIGS. 2 and 6 together, the electrical power generation system 208 can be an exemplary electrical power generation system 600. The system 208 can comprise one or more power producers (i.e., power generation modules 631a, 631b) in communication with a fuel gas supply line 620 such that power generation modules 631a, 631b may receive a fuel gas stream 602 therefrom (e.g., natural gas). The power generation modules 631a, 631b are further shown to optionally be in electrical communication with an electrical transformation module 635 such that an electrical output 603 may be transmitted from the power generation modules 631a, 631b to the electrical transformation module 635.

In one embodiment, the power generation modules 631a, 631b may each comprise a generator component adapted to generate an electrical output 603 via combustion of the natural gas 602. Generally, the generator component may employ either a fuel-gas-driven reciprocating engine or a fuel-gas-driven rotating turbine to combust the natural gas 602 and drive an electrical generator.

As detailed below, each power generation module 631a, 631b may be associated with various producer information, such as operational requirements, measured or determined producer metrics, and statistics determined over a time period.

In certain embodiments, the employed power generation modules 631a, 631b may each be specified to operate with natural gas 602 having a wide variety of properties. For example, certain modules may include generator components adapted to utilize rich natural gas or natural gas that has been processed to such that it is substantially free of propane and higher hydrocarbons (C3+) components.

The producers may be associated with a gas consumption rate, which refers to the volume of natural gas consumed by the generator within a given time period. The gas consumption rate may be determined for continuous operation of the generator at standard ambient conditions. Generally, the gas consumption rate of engine-type generators may range from about 40 Mscfd to about 500 Mscfd. And the gas consumption rate of turbine-type generators may range from about 1 MMscfd to about 6 MMscfd.

The power producers may further be associated with a generated power output that refers to the electrical energy output by a given generator after efficiency losses within the generator. This property is often referred to as “real power” or “kWe.” The generated power output may be provided as “continuous power,” which refers to the real power obtained from the generator when the module is operating continuously at standard ambient conditions.

Generally, engine-type generators may produce an electrical output ranging from about 70 kW to about 2 MW, with an associated voltage ranging from about 208 V to about 4.16 kV. Exemplary engine-type generators may output power at approximately 120/240 VAC single-phase, 120/208 VAC 3-phase, 220/380-400 VAC 3-phase, 240/415 VAC 3-phase, 277/480 VAC 3-phase, etc. And turbine-type generators may produce an electrical output ranging from about 2 MW to 30 MW, with an associated voltage ranging from about 4.16 kV to about 12 kV.

It will be appreciated that the various generator components employed in the power generation module 631 may be adapted to operate reliably in harsh conditions, and with variability in gas rates, composition and heating values. Moreover, it will be appreciated that the specific generators employed in each of power generation modules 631a, 631b may be selected and configured based on the specifications and availability of natural gas at a particular location.

As shown, each of power generation modules 631a, 631b may optionally be in further communication with a backup fuel supply 637 containing a backup fuel 608. In one embodiment, the backup fuel supply 637 may comprise a natural gas storage tank containing pressurized natural gas. In another embodiment, the backup fuel supply 637 may comprise an on-site reserve of propane. At times of low gas availability, the backup fuel 608 may be piped directly to the power generation modules 631a, 631b, from the backup fuel supply 637.

Fueling for the power generation modules will primarily be with natural gas which may be either pipeline quality or non-pipeline quality. Back-up fueling may be either vaporized natural gas liquids or diesel.

Typically, each of the power generation modules 631a, 631b will further comprise various ancillary components (commonly referred to as the “balance of plant”). Such components may include, but are not limited to, compressors, lubrication systems, emissions control systems, catalysts, and exhaust systems. The power generation modules 631a, 631b may optionally comprise integrated emissions reduction technologies, such as but not limited to, a non-selective catalytic reduction (“NSCR”) system or a selective catalytic reduction (“SCR”) system.

In one embodiment, the power generation modules 631a, 631b may each comprise a housing designed to contain and protect the above-described components of the module. Such housing may provide features such as, but not limited to, weatherproofing, skid or trailer mounting for portability, and sound attenuation.

In certain embodiments, the power generation modules 631a, 631b may each be supported by a transportable chassis, trailer, or railcar to facilitate positioning and/or repositioning of the module. More particularly, the transportable chassis, trailers, or railcars may be coupled to vehicles, such as trucks or trains, and transported over a geographic area. The generator skids can range in size from an enclosed trailer hauled behind a pickup truck, to a plurality of semi-trailer loads for the generator and its required ancillary equipment.

As shown, each of the power generation modules 631a, 631b can include one or more sensors 670 for measuring or determining various power producer metrics. Each of the modules can further include a respective modbus controller 672 for transmitting producer information (e.g., metrics) to one or more other system components (e.g., control system 101, controller 114 and/or controller 124). Although referred to herein as a modbus controller 672, such component can communicate via any suitable communication protocol, such as but not limited to: Modbus, BACNet, RTU/TCP, Ethernet/IP, OPC, CAN or LonWorks. Generally producer metrics may be retrieved from the controller 672 at predetermined intervals, for example every 15 seconds.

System 600 can further include an inlet pressure sensor 674 configured to measure the pressure of gas entering into gas supply line 620. In one embodiment, there can be a single pressure sensor 674 for an entire site, and the value measured by the single inlet pressure sensor 674 can be used in correlation with each power generation module 631a, 631b fed by gas supply line 620. In another embodiment, the system may include one inlet pressure sensor per power generation module 631a, 631b. In any event, one or more controllers (e.g., control system 101, controller 114 and/or controller 124) may be configured for retrieving inlet gas pressure measurements from the inlet pressure sensor(s).

In some embodiments, the electrical power production system 600 may comprise an electrical transformation module 635 in electrical communication with the power generation modules 631a, 631b. In such cases, the electrical power 603a, 603b generated by each of the power generation modules 631a, 631b may be transmitted through the electrical transformation module 635 such that it may be converted into an electrical flow 605 that is suitable for consumption by the power consumption system 103.

In certain embodiments, the power production system may comprise a main breaker capable of cutting off all downstream electrical flows, which allows an operator to quickly de-power any attached computing equipment in the case of operational work or emergency shut-down. Additionally or alternatively, component terminals may be fitted with “quick connects.”

As shown, each of the electrical transformation modules 635 can include one or more sensors 676 for measuring or determining various producer metrics. The modules can further include a respective controller 678 for transmitting the producer metrics to a controller (e.g., container controller 114, 124 or the remote control system 101). In certain embodiments, controller 678 can comprise a modbus controller such that the metrics may be fetched from the modbus controller at predetermined intervals, for example every 15 seconds, every 5 second and every 1 second. In certain embodiments, some metrics can be sampled at shorter time intervals (e.g., every 0.5 seconds) and other metrics can be sampled at longer time intervals (e.g., every 30 seconds), depending on the expected rate of change of the metric. It will be appreciated that any number of power generation modules 631a, 631b and electrical transformation modules 635 may be included in the power production system 200. For example, the power generation modules 631a, 631b may be directly wired from a terminal of each of the power generation modules 631a, 631b into a primary side of the electrical transformation module 635. As another example, two or more sets of power generation modules 631a, 631b and electrical transformation modules 635 may be employed, in a series configuration, to power any number of computing components.

In one particular embodiment, the electrical power production system 200 may comprise multiple power generation modules 631a, 631b connected in parallel. In such embodiments, the multiple electrical power generation modules 631a, 631b may be phase-synced such that their output electrical flows 603a, 603b may be combined without misalignment of wave frequency. As shown, the multiple phase-synced electrical flows 603a, 603b may be wired into a parallel panel 660, which outputs a single down-stream flow 604 with singular voltage, frequency, current and power metrics.

In one such embodiment, the singular down-stream flow 604 may be wired into a primary side of an electrical transformation module 635 for voltage modulation. For example, as discussed above, the singular down-stream flow 604 may be transmitted to the electrical transformation module 635 such that the flow may be converted into an output electrical flow 605 that is suitable for consumption by various components of the power consumption system.

Generally, each of the power generation modules 631a, 631b and/or the parallel panel 660 may comprise a control system that allows for the module to be synchronized and paralleled with other power generation modules. The control system may allow load-sharing of a plurality of power generation modules (e.g., up to 32 power generation modules) via a data link and may provide power management capabilities, such as load-dependent starting and stopping, asymmetric load-sharing, and priority selection. Such functionality may allow an operator to optimize load-sharing based on various producer metrics, for example, running hours and/or fuel consumption.

### Monitoring and Control System

As noted above, monitoring and control system 214 (FIG. 2) can include control system 101, container controllers 114, 124, the sensors 620, 670, 674, 676 and the controllers 672, 676. Each container 110, 120 may comprise a container controller 114, 124 configured to communicate with the central control system 101 and the DCUs of the respective container (discussed below). For example, as noted above, a first container 110 may include a plurality of first DCUs 112 and a first container controller 114 configured for controlling the first DCUs 112. And a second container 120 may include a plurality of second DCUs 122 and a second container controller 124 configured for controlling the second DCUs 122. In each case, the respective container controller 114, 124 may control the associated DCUs 112, 122 based on metrics received from the DCUs (or other container components) and/or according to instructions received from the central control system 101.

As shown, each container controller 114, 124 may include a controller processor 114a, 124a, a controller memory 114b, 124b, and a container orchestrator 114c, 124c. Each container controller 114, 124 is generally configured to determine consumer metrics for each power consumer associated with the respective container and container metrics corresponding to the respective container (discussed in detail below). The container controller 114, 124 may further be configured to store such metrics in the respective controller memory 114b, 124b.

Each container controller 114, 124 may include a control module 114d, 124d adapted to adjust operating parameters of associated power consumers (e.g., DCUs 112, 122). As detailed below with respect to method 1300, the container controllers 114, 124 may employ the control modules 114d, 124d to determine an optimal power consumption distribution model to balance a load of the container(s) to a target power received from the control system 101. The control module 114d, 124d may then output the optimal power consumption distribution model for adjusting a power state of one or more power consumers in order to balance the power consumers' power consumption based on the target power production. Moreover, the control module may select DCUs and/or particular DCU processors for such adjustment, based on consumer metrics associated with each of the power consumers; to satisfy predetermined requirements or constraints; and/or to optimize a total utility of the power consumers (e.g., revenue generation, hash power, uptime, etc.).

For each site, a single power control module (e.g., power control module 114d) can be elected as a leader to perform the power control determinations that are used to increase or decrease the power of one or more of DCUs 112, 122 or other power consumers.

The leader can be chosen by the central coordinator 130, which informs the leader which devices of power production system 200 and power consumers of power consumption system 103 to fetch metrics from, and which devices are associated with each power consumer. Coordinator 130 can send a request to all container controllers 114, 124 (i.e. locations) at predefined time intervals (e.g., every 60 seconds), and keeps track of the last ping for each of power control module 114d, 124d. In one embodiment, central coordinator 130 sends a request ping to all current power control module leaders at predefined time intervals, (e.g., every 1 to 30 seconds). If a leader is unresponsive for more than a predefined time intervals, e.g., 20 to 300 second, or at least 2 pings, e.g., 2 to 10 request pings, such unresponsiveness triggers a leader re-election. For the leader re-election, the container controller 114, 124 with the most recent ping time is elected as new leader, and the new leader is notified via a leader notification. In some embodiments, the leader notification can be an API call.

Each site can include a plurality of containers (e.g., two or more of containers 110 and/or two or more of containers 120), each including a container controller 114, 124, interfaces 136 and DCUs. The container controllers and DCUs of each site can be connected via a single local area network (LAN) that is in communication with network 134. For each LAN, a single power control module 114d can determine an optimal power consumption distribution model for distributing target power deltas to all of DCUs 112, 122 on the LAN so that the leader power control module 114d distributes power consumption instructions to a plurality of container orchestrators 114c, 124c. This single power control module can be deemed the leader. In other embodiments, a separate LAN can be provided for each container—i.e., each container controller and DCUs of the corresponding container can be connected to a respective LAN, and a single power control module 114d can determine an optimal power consumption distribution model for distributing target power deltas to all of DCUs 112, 122 on multiple LANs so that the leader power control module 114d distributes power consumption instructions to a plurality of container orchestrators 114c, 124c each on a respective LAN.

System 100 can be configured to communicate with client computers 138 seeking computing resources in the form of virtual machines running on DCUs 112, 122. Client computers 138 can access, via a public network, a web page or application generated by an intermediate system 144, which can be a web server or application server, and submit a request to access a virtual machine generated by DCUs 112, 122. The request can include a requested number of GPUs for running the virtual machine, and this request can be communicated to coordinator computer 114 to connect the client computer 138 to respective DCUs 112, 122.

Each of DCUs 112, 122 can include multiple GPUs, and each of the first and second DCUs 112, 122 can be configured for running one or more virtual machines. Each GPU can be adapted to run a single virtual machine alone or together with one or more of the other GPUs of the respective DCU 112, 122.

The coordinator computer 114 is configured to receive a request via intermediate system 144 from client computer 138 to access a virtual machine, and in response to the request, to retrieve the currently available computing capacity for each of the first and second DCUs 112, 122, and to establish the virtual machine on the first or second DCUs 112, 122 based on the currently available computing capacity.

The system orchestrator 130c is configured to automatically determine location information including the physical container 110, 120 in which the respective network interface 136 is located and a position of the respective network interface 136 within the physical container 110, 120 based on the network address of the respective network interface 136. Each of the network interfaces 136 can have preassigned container identifier, a preassigned rack identifier, a preassigned shelf identifier and a preassigned shelf position identifier, and this information is automatically determined by the system orchestrator 130c upon the connecting of the new DCU 112, 122 to the network interface 136.

The container orchestrator 114c can monitor and update further metrics of each DCU by periodically sending a metrics request to the DCUs, and the DCUs sending the metrics in response to the request. For example, each DCU can include a plurality of chips or processors (e.g., GPUs, CPUs or ASICS) associated with one or more circuit boards (e.g., a serverboard or hashboard). The container orchestrator 114c can periodically send the metrics request to a DCU to obtain a maximum chip temperature for the chips of each associated circuit board, along with an average temperature for each circuit board. In certain embodiments, the metrics may further comprise a computational power of the DCU (e.g., a hashrate of a cryptocurrency miner).

The system orchestrator 130c can associate the location information with a corresponding object in an inventory model. As noted above, this location information can include the physical container 110, 120 in which the new DCU 112, 122 is located and the position of the respective network interface 136 within the physical container 110, 120. This location information can be in the form of a preassigned container identifier, a rack identifier, a shelf identifier and a shelf position identifier.

Data records for containers 110, 120 include container information of each of the physical containers 110, 120. The container information can include information describing the geographical location of the physical container, a container identifier for the physical container, a size of the physical container, a type of the physical container and a cost of the physical container. The data records for DCUs 112, 122 include the location information for each of the DCUs in communication with the network 134. The container information and/or location information are automatically assigned to each DCU 112, 122 in communication with the network 134 based on the network address of the respective network interface 136.

The physical containers 110, 120 can each include a plurality of racks having predefined rack positions configured for receiving the DCUs, and each of the predefined rack positions can be associated with one of the network interfaces. Memory 130b can be partitioned to store the predefined rack positions and the associated network interfaces, and the system orchestrator 130c can be configured to automatically assign the predefined rack position associated with the network interface 136 with which the DCU is connected to the corresponding data record.

The physical containers 110, 112 can be located at different physical sites and each of the physical sites can have at least one of the physical containers 110, 112 and at least one of the physical sites can have a plurality of physical containers. The system orchestrator 130c can be configured for causing the processor to generate a graphical user interface depicting the physical sites, the physical containers within the physical sites, the predefined rack positions within the containers, and the DCUs in the predefined rack positions.

The container information and/or position information of each DCU can be dynamically adjusted by the system orchestrator 130c in response to a disconnection of the DCU from the respective network interface 136 and a reconnection of the DCU to a different network interface in a different physical container or the same physical container.

In embodiments where DCUs include a plurality of GPUs (e.g., each DCU 112 comprises a server having multiple GPUs), the data record can include a number of GPUs for each DCU, a number of currently available GPUs for each DCU, and a number of currently utilized GPUs for each DCU. During operation, a CPU of the server can run one or more virtual machine instances, wherein each instance comprises one or more of the GPUs of the respective DCU. In such cases, the data record can include instance information for each such instance, wherein the instance information includes the one or more GPUs associated with the respective virtual machine instance. The data record can also include the number of GPUs of each DCUs currently associated with virtual machines and an excess capacity (i.e., unused GPUs) available for running further virtual machines for each DCU.

In embodiments where the interruptible computing load container DCUs 122 include cryptocurrency miners, the data records can include financial metrics related to the cryptocurrency miner. The financial metrics can include at least one of a purchase price of the cryptocurrency miner, a depreciation of the cryptocurrency miner or a profit generated by the cryptocurrency miner. Each of the data records can also include repair and/or maintenance history information for the cryptocurrency miner including financial costs associated with the repair and/or maintenance. Further, each of the data records can include a hash rate for the cryptocurrency miner.

In such embodiments, memory 130b can store information with respect to containers 110, 112, racks, and individual DCUs. For example, metrics for a specific container can include the total number of DCUs online and offline for the container, the current fuel level and fuel consumption rate of the generator powering the DCUs of the container, the power consumption by the DCUs of the container over time shown in graph, the gas pressure of the generator powering the DCUs of the container over time shown in a graph, an average maximum chip temperature for the DCUs of the container over time shown in a graph. Where a container includes cryptocurrency miners, metrics for the container can include the total hashrate of all of the DCUs of the container together (current value and over time on a graph), a mining pool hashrate, the load of the generator powering the DCUs of the container.

With respect to computing resource allocation for DCUs 112, 122, first container orchestrator 114c is configured to store in the first controller memory 114b or periodically transmit data including a total power consumption capacity and a currently available power consumption capacity for each of the first DCUs 112. Similarly, second container orchestrator 124c is configured to store in the second controller memory 124b or periodically transmit data including a total power consumption capacity and a currently available power consumption capacity for each of the second DCUs 122. The system orchestrator 130c is configured for communicating with the first and second container orchestrators 114c, 124c to obtain the total power consumption capacity and the currently available power consumption capacity for groups of the DCUs 112, 122.

Container orchestrators 114c, 124c can also create a consumer object in memory 114b for all of the DCUs 112, 122 within the respective container 110, 120 or can create more than one consumer objects from the DCUs 112, 122 within the respective container 110, 120, with subsets of DCUs 112, 122 being in different consumer objects based on utility values of the DCUs, as described in further detail below. For example, DCUs 112 in container 110 can group into separate consumer objects including DCUs having a utility value within a first range being represented by a first consumer object, DCUs having a utility value within a second range being represented by a second consumer object, and DCUs having a utility value within a third range being represented by a third consumer object. Container orchestrators 114c, 124c fetch real time power consumption metrics for the respective DCUs 112, 122c and combines these real time power consumption metrics to populate a record associated with each of the consumer objects in real time with the cumulative power consumption values for the DCUs represented by the respective consumer object.

The monitoring and control system 214 is also configured to receive status inputs, including but not limited to, an operational status of each of the renewable energy source 206A and the electricity grid 206B indicating an availability of electricity from each of the renewable energy source 206A and the electricity grid 206B to power the data center 110. The status inputs may also include an operational cost of each of the renewable energy source 206A and the electricity grid 206B indicating a price of electricity from each of the energy source 206A and the electricity grid 206B.

Monitoring and control system 214 is also configured to output a control signal to the power switching system 212 to switch from the primary power sources 206A, 206B to electrical power generation system 208 to supply electricity to the DCUs 112 based on the status inputs. During this switching, at least some of the electricity generated by the electrical power generation system 208 is redirected from the DCUs 122 to the data center 110 in response to the control signal from monitoring and control system 214.

Monitoring and control system 214 is generally adapted to maintain processing conditions within acceptable operational constraints throughout the system. Such constraints may be determined by economic, practical, and/or safety requirements. The monitoring and control system 214 may handle high-level operational control goals, low-level PID loops, communication with both local and remote operators, and communication with both local and remote systems.

### Power Switching System

The power management system 100 further includes a power switching system 212 configured to supply electricity to the data centers 102 from either the primary power source(s) 206A, 206B or the electrical power generation system 208. The power switching system 212 may be in communication with a monitoring and control system 214, for example, via a network 134. The power switching system 212 can, for example, include a plurality of mechanical breaker switches or switchgear, which can be actuated by a programmable logic controller (PLC) or distributed control system (DCS), that are distributed throughout the power management system 100.

### Carbon Capture System

The power management system 100 may comprise a carbon capture system 118 configured to receive exhaust gas from power generation module(s) of the power generation system 208 and remove carbon therefrom. Generally, the carbon capture system 118 can advantageously capture and remove at least 75% of the carbon from the exhaust gas.

In one embodiment, the carbon capture system 118 can remove carbon dioxide from the exhaust gas using a solvent, which is then heated to separate the carbon molecules (e.g., as CO2). A CO2 stream may then be compressed and injected into a sequestration well near the system or may be routed to a dedicated CO2 pipeline. The solvent may be an amine solvent, for example monoethanolamine (MEA).

In another embodiment, the carbon capture system 118 may comprise one or more membranes, such as a spiral-wound cellulose acetate membrane. Generally, the membrane operates on the principle of selective permeation, where components with higher permeation rates (e.g., CO2) permeate through a membrane faster than those with lower permeation rates. Accordingly, a CO2-rich (permeate) stream may be separated from the exhaust stream.

It will be appreciated that the carbon capture system 118 may be adaptable to various gas volumes and carbon concentrations. Moreover, operational parameters of the carbon capture system 118 may be monitored and/or controlled via various equipment in communication with the monitoring and control system 214 (e.g., via a network 134).

### Communication System

As shown, the system 100 may comprise a communication system 132 that provides a network 134 to which various components may be connected. The network 134 may include wide area networks (“WAN”), local area networks (“LAN”), intranets, the Internet, wireless access networks, wired networks, mobile networks, telephone networks, optical networks, or combinations thereof. The network 134 may be packet switched, circuit switched, of any topology, and may use any communication protocol. Communication links within the network 134 may involve various digital or an analog communication media such as fiber optic cables, free-space optics, waveguides, electrical conductors, wireless links, antennas, radio-frequency communications, and so forth. In one embodiment, monitoring and control system 214 can communicate with power switching system 212 (e.g., via network 134).

### Power Management

In one embodiment, the monitoring and control system 214 may be in communication with various monitoring and control equipment, such as sensors and/or controllers (e.g., control system 101, container controllers 114, 124, the sensors 620, 670, 674, 676 and the controllers 672, 676), via the network 134. Such monitoring and control equipment may be in further communication with various components of the data center 110, primary power sources 206A, 206B, the electrical power generation system 208, the interruptible computing load container 120 and power switching system 212, such that the monitoring and control system 214 may remotely monitor and control operating parameters throughout the power management system 100.

Monitoring and control system 214 can receive various system metrics, including the required power for data center 110, the power availability and power price associated with electricity grid 206B, the power availability and power price associated with renewable energy source 206A, generator metrics and gas metrics from power generation modules of the electrical power generation system 208, and a miner status for each of the cryptocurrency miners of the interruptible computing load container 120.

For directing operations of power switching system 212, the status inputs can include a mining profit generated by the cryptocurrency miners (e.g., expressed in dollars per unit of electrical energy). The mining profit can be a function of a current market price of the cryptocurrency, a hash rate of the employed cryptocurrency miners, a mining difficulty metric, and/or power consumption of the cryptocurrency miners. The mining profit can also take into account a price of fuel gas per unit and power generated per unit of fuel gas by the power generation modules. In certain embodiments, the mining profit may also include a cost of thermal management for the cryptocurrency miners.

In one embodiment, the monitoring and control system 214 can be configured to output a control signal to the power switching system 212 to switch from the primary power source(s) 206A, 206B to the electrical power generation system 208 to supply electricity to the DCUs 112 of the data center 110 when a price of electricity from a least expensive of the primary power sources 206A, 206B is greater than a threshold price. An exemplary threshold price may be derived from a value of the cryptocurrency with respect to a government currency, a hashrate of the cryptocurrency miners, a mining difficulty metric, and/or a cost to operate the cryptocurrency miners.

Generally, the monitoring and control system 214 is configured to direct the power switching system 212 to maximize a total profit equal to a net profit of operating the data center 110 plus a net profit of operating the cryptocurrency miners of interruptible computing load container 120, and is configured to direct the power switching system 212 to shut down the cryptocurrency miners of interruptible computing load container 120 and to power the data center 110 by the electrical power generation system 208 when doing so maximizes the total profit. Similarly, monitoring and control system 214 is configured to direct the power switching system 212 to restart and power the cryptocurrency miners of the interruptible computing load container 120 via electricity generated by the electrical power generation system 208 and to power the data center 110 via the primary power sources 206A, 206B when doing so maximizes the total profit.

Power management can also be performed by the monitoring and control system 214 in accordance with method 1300 discussed in detail below.

### Power Consumption and Production Metrics

In some embodiments, the system 100 may comprise an inventory management system, which may be employed to model and monitor various system components such as: sites, power producers (e.g., power generation modules, electrical transformation modules, etc.) and power consumers (e.g., containers, DCUs, etc.).

In one embodiment, the inventory management system may determine and store site information for each site 108. Exemplary site information may include: site ID, operator information, location information (e.g., address and/or coordinates), fuel gas information (e.g., heat values, volumes, composition), network equipment information, associated power consumers information (e.g., associated power consumers and associated containers) and associated power producers information.

The system may model and manage power consumers information for any number of power consumers (e.g., DCUs 112, 122). Such information may comprise, for example: a unique ID, associated container information, and consumer information for each power consumer associated with each of the associated containers.

Exemplary container information may include: container ID, associated site, associated power producers, container type (e.g., manufacturer, model), networking information (e.g., container modbus URL), VLANs information (e.g., main, ASIC, IoT, etc.), controller information (controller ID, IP address, IP port), layout information of DCUs inside a container, associated DCUs, and various container metrics.

Exemplary consumer information may include, but is not limited to: unique ID, hardware identifier, network information, associated container and location information, consumer type (e.g., manufacturer, model), processor information (e.g., type, count, temperature, etc.), fan speed, hashrate or processing power, board information (e.g., temperature), software information, uptime, financial information (e.g., cost, revenue per processor over a given time period, mining pool information), customer information, owner information, status information and/or priority information.

Generally, each of the consumers (e.g., DCUs 112, 122) has a preassigned unique hardware identifier accessible to the system orchestrator 130c via the network. For example, the preassigned unique hardware identifier can be a media access control (MAC) address. Each of the consumers can also be associated with a unique inventory identifier that is different from the MAC address and is an ID assigned by the system orchestrator 130c. User device 138 can be a client computer, for example a mobile phone.

Each of DCU 112, 122 is connected—either directly or indirectly—to a respective one of the network interfaces 136, for example by an ethernet cable of the network 134 that is in communication with the network interface 136 being plugged into a port of the DCU 112, 122.

As mentioned above, each container may be associated with layout information corresponding to a plurality of racks disposed within a container. Each rack may comprise a plurality of shelves, where each shelf comprises various slots into which DCUs may be installed. Accordingly, each slot represents a unique physical location that may be employed to determine the physical location of a particular DCU if such components are correlated by the system.

To that end, each slot may be configured to include one of the network interfaces 136 of the communication system 132, wherein each interface may be assigned a unique, static network address. Accordingly, when a DCU is connected to the particular network interface 136, the DCU may be automatically associated with the corresponding network address. Because the network address uniquely identifies a particular slot in a shelf of a rack located in a container disposed at a site, the network address association allows for a physical location to be determined.

With respect to power producers, the system may monitor, determine and/or store producer information such as: producer ID, producer type, an associated site, networking information (e.g., generator modbus URL, ECU modbus URL), operations constraints and requirements, producer metrics, producer statistics, and producer controls.

As shown in Table 1, the system may monitor and/or calculate current values for some or all of the listed power producer metrics. Power producer metrics are quantifiable measures that assess operation of a power producer at a specific time.

TABLE 1
Power Producer Metrics

| | |
|---|---|
| Power Generation | Current generator output power (kW) |
| Engine Output | Current engine output (kW) |
| Engine Pressure | Current engine fuel pressure (psi) |
| Coolant Temperature | Current engine coolant temperature (° F.) |
| Surface Temperature | Current producer surface temperature (° F.) |
| Cylinder Positions | Current position of each cylinder (16) |
| Fuel Quality | Current fuel quality (e.g., heat value). |
| | Various operational parameters may be |
| | dynamically adjusted based on the Fuel Quality |
| Engine Run Time | Total engine run time (hours) |
| Engine Load Percent | Percent torque/available engine load |
| Engine Load % EMA | Engine Load Percentage Exponential Moving |
| | Average (we use an EMA to account for noise |
| | in the original metric fetched) |
| Is Knocking? | Compare Current Cylinder Position to Reference |
| | Cylinder Position for each cylinder. True only |
| | if at least 2 cylinders are at least 2 degrees |
| | away from their respective Reference Position |
| Fuel Consumption | Current fuel gas consumption at current Engine |
| | Output and estimated fuel gas heat value (Gross |
| | Heating Value - Dry) (mcf/d) |

In certain embodiments, the system may calculate producer statistics over one or more time periods by analyzing historical values of such power producer metrics. Exemplary statistics include slope, standard deviation, and exponential moving average (EMA). In certain embodiments, the system determines engine pressure slope, engine pressure EMA, coolant temperature slope and/or coolant temperature EMA. Such statistics may be determined for various time periods.

As shown in Table 2, power producers may be associated with certain operational requirements that must be observed and can be used to create setpoints for determining target powers for the power producers. Such requirements may be predetermined (e.g., based on producer type or model) or may be dynamically adjusted according to values of certain producer metrics (e.g., based on a current Knock Index).

TABLE 2
Producer Operational Requirements

| | |
|---|---|
| Max Engine Output | Maximum engine output power (kW), which |
| | the target power should not exceed |
| Max Generator Power | Maximum generator output power (kW) |
| Max Engine Load Percent | Maximum engine load percent |
| Min Engine Pressure | Minimum engine fuel pressure to be |
| | maintained (psi) |
| Max Cylinder Exhaust | Maximum cylinder exhaust temperature for |
| Temperature | any given cylinder (° F.) |
| Reference Cylinder | Optimal position of each cylinder of a |
| Position | given producer |
| Min Inlet Pressure | Minimum inlet fuel pressure to be |
| | maintained (psi) |
| Max Coolant | Maximum engine coolant temperature (° F.) |
| Temperature | |
| T5 Temperature | Maximum surface temperature generator can |
| | reach under normal operating conditions |

In certain embodiments, the producer metrics can also include various monetary metrics. As an example, producer metrics may comprise a real-time nodal price for the power supplied directly behind-the-meter from renewable energy source 206A (e.g., a wind-farm). It will be appreciated that the monetary metrics may additionally or alternatively include contractual provisions, for example, a price floor structure triggered when the nodal price drops below a certain value (e.g., a negative value).

In such cases, power can for example be provided from grid 206B at a load zone price in ERCOT, which is calculated on a 15 min interval basis. The monitoring and control system 214 can receive inputs of the operational cost (i.e., power price) of each of the power sources and can have a hedge price in place, for example an around the clock hedge, and can switch from the grid 206A to electrical power generation system 208 to power data center 110 when the power price is greater than the hedge price+bitcoin mining margin.

In addition to switching between primary power sources 206A, 206B, the monitoring and control system 214 may be adapted to automatically switch between the primary power source 206A, 206B and the electrical power generation system 208 to provide power to the data center 110. For example, the control system may switch from the primary power source to the electrical power generation system when:
Power Price>Threshold Price,
where Threshold Price=Hedge Price+Mining Profit+Switching Cost.

The Power Price may be received from a third-party system and may comprise a real-time nodal price (optionally including a price floor structure), or a load zone price (e.g., calculated in 15-minute intervals).

The Hedge Price may be manually input into the system or may be automatically received from a third party system and may comprise a contractual maximum power price or an “around-the-clock” price.

The Mining Profit may be determined by the monitoring and control system 214 based on various inputs. As discussed above, mining profit can be a function of a current market price of the cryptocurrency being mined, a hash rate of the employed cryptocurrency miners, a mining difficulty metric, and/or power consumption of the cryptocurrency miners. The mining profit can also take into account a price of natural gas per unit and power generated per unit of natural gas by the power generation modules. In certain embodiments, the mining profit may also include a cost of thermal management for the cryptocurrency miners.

Finally, Switching Cost may be determined to reflect the operational complexity with switching between the compute assets. Generally, the system 100 may employ a minimum time requirement wherein the system 100 will not switch power sources unless the Power Price is greater than the Threshold Price for at least a minimum time requirement.

### General Power Supply Control Algorithm

A supply of power to the power consumption system 103 by the power production system 105 can be controlled by a general power supply control algorithm. While described below with respect to FIG. 1, it should be understood that this method is generally also applicable to both the system in FIG. 2 and the system in FIG. 11.

The method can include a first step of measuring and/or receiving metrics of the power production system 105 while powering the power consumption system 103.

The power consumption system 103 includes a plurality of computing units including at least a set of first computing units (e.g., DCUs 112 associated with data center 110) and a set of second computing units (e.g., DCUs 122 associated with interruptible computing load container 120). The first DCUs 112 are in communication with a server 144 for providing cloud services to remote client computers 138.

In one embodiment, the first computing units may be associated with an energy priority over the second computing units such that, in the event of a reduction in power production, some or all of the second DCUs 122 will be powered down or off to allow the first DCUs 112 to continue to operate. In one such embodiment, the second computing units may comprise cryptocurrency miners, which can be powered down at any time without impacting third-party customers. It will be appreciated that shutting down the first computing units would negatively impact third-party customers using the cloud services provided via the first computing units.

In another example, the second computing units (DCUs 122) may comprise CPUs and/or GPUs adapted to provide interruptible or so-called “spot” or “preemptible” cloud services to third-party customers paying a lessor price than the customers using the first computing units (DCUs 112). The customers using the second DCUs 122 have agreed to pay a discounted price in comparison to the price paid by the customers using the first DCUs 112, on the condition that the second DCUs can be powered down at any time in the event of a reduction in power production, while the first DCUs 112 continue to be powered.

The power production system 103 includes power sources including a first power source and a second power source. The second power source includes a power generation module 631a, 631b configured to consume natural gas and continuously generate an electrical output sufficient to alternatively power the plurality of first DCUs 112 and the second DCUs 122.

The method can also include determining, from the metrics of the power production system, an operational status and/or an operational cost of each of the power sources; and decreasing a power consumption of the second DCUs and powering the first DCUs by the second power source based on the operational status and/or the operational cost of each of the power sources.

In one example, referring to the embodiment in FIG. 2, a second power source (e.g., electrical power generation system 208) can power interruptible computing load container 120 when data center 110 is being powered by a first power source (e.g., renewable energy source 206A or electrical grid 206B). Alternatively the second power source can power data center 110 when the switching algorithm provides instructions to switch from powering interruptible computing load container 120. The decision of which of data center 110 or interruptible computing load container 120 for the second power source to alternatively power can be based on an operational status of each of the one or more primary power source(s) (206A, 206B), which respectively indicates an availability of electricity to power the data center 110. Additionally or alternatively, such decision may be based on an operational cost of each of the one or more primary power source(s) (206A, 206B), which indicates a respective price of electricity. For example, interruptible computing load container 120 can be powered off when the electrical power generation system 208 is powering the data center 110. The operational status can be based on the producer metrics, including for example those discussed with respect to Table 1.

In another example, referring to the embodiment in FIG. 11, both the first power source 1104A and the second power source 1104B can each be an electrical power generation system 208 comprising a power generation module. In the event of the failure of one of the power generation modules or if one of the power generation modules is shut down for maintenance, the interruptible computing load container 120 (see also FIG. 11 at 1116) can be powered off so that the remaining power generation module powers data center 110 (see also FIG. 11 at 1112).

### Exemplary Configurations

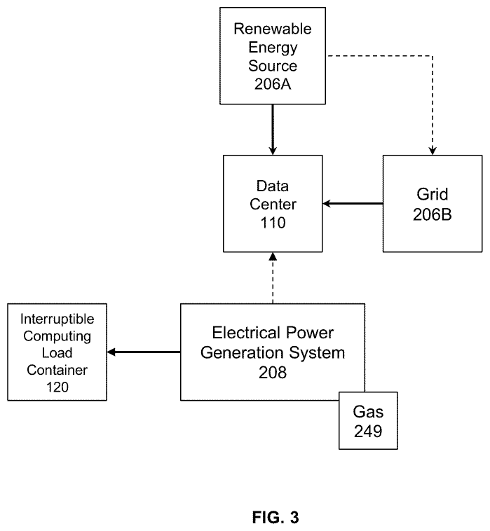

Referring to FIGS. 3-5, various conditions of the power management system are illustrated. FIG. 3 shows the power management system 100 in a first condition where the electrical power generation system 208 is powering the interruptible computing load container 120 and the data center 110 is powered by a primary power source 206A, 206B. As shown, the monitoring and control system 214 directs the power switching system 212 to power the interruptible computing load container 120 and to direct at least one of the primary power sources 206A, 206B to power the data center 110. In the first condition, the price of electricity from primary power sources 206A, 206B is determined to be below the threshold switching price.

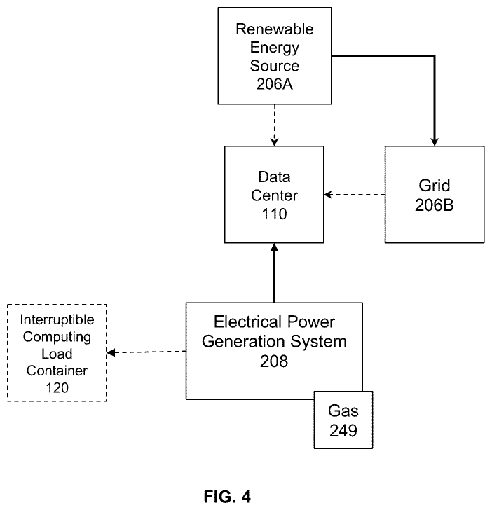

FIG. 4 shows the power management system 100 in a second condition where the electrical power generation system 208 is powering the data centers 110. It will be appreciated that, in this condition, the interruptible computing load container 120 is not receiving power from the electrical power generation system 208 and, thus, the miners or GPUs therein are turned off. It will be further appreciated that, in this condition, the data centers 110 are fully powered by the electrical power generation system 208 and, thus, are not pulling electricity from the primary power source 206A, 206B.

As shown, the monitoring and control system 214 directs the power switching system 212 to electrically decouple the electrical power generation system 208 from the interruptible computing load container 120, to electrically decouple the primary power sources 206A, 206B from the data center 110, and to direct the electrical power generation system 208 to power the data center 110. In the second condition, the price of electricity from primary power sources 206A, 206B is greater than the predetermined threshold price, and renewable energy source 206A can sell electricity back to the electricity grid 206B.

In some embodiments the monitoring and control system 214 may retrieve information from a database to determine expected/actual usage information relating to the DCUs 112 of the data center 110. In such cases, the monitoring and control system 214 can calculate required power information in order to direct the required power to the data center 110. If available, the monitoring and control system 214 can direct excess power to the interruptible computing load container 120.

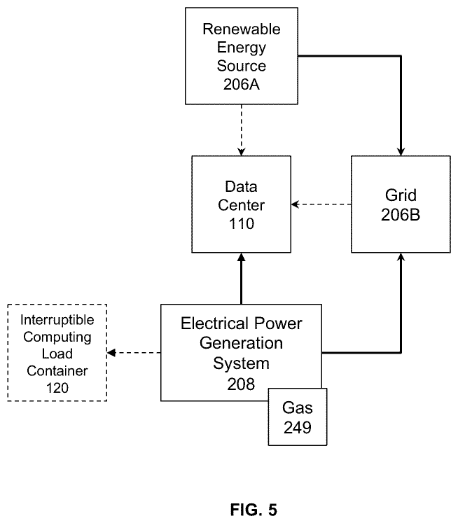

FIG. 5 illustrates power management system 100 in a third condition. As shown, the monitoring and control system 214 directs the power switching system 212 to electrically decouple the electrical power generation system 208 from the cryptocurrency miners, to electrically decouple the primary power sources 206A, 206B from the data center 110, and to direct the electrical power generation system 208 to power the data center 110. In this embodiment, the price of electricity from primary power sources 206A, 206B is determined to be greater than the threshold switching price.

In the illustrated embodiment, renewable energy source 206A can sell electricity to the electricity grid 206B. The monitoring and control system also directs the electrical power generation system 208 to provide any excess power (i.e., power in excess of that required to power data center 110) to the grid 206B. It will be appreciated that, in such cases, the electrical power generation system 208 must be in electrical communication with the grid 206B such that the excess power may be provided thereto. Accordingly, the operator of the power management system 100 avoids purchasing electricity at a high price and potentially participates in any upside with respect to the sale of electricity to the grid by the renewable energy source 206A and/or via the electrical power generation system 208.

It will be appreciated that, in other embodiments, power produced by power generation system 208 is not sold to the grid 206B. Nevertheless, power generation system 208 can increase operator profits by powering the data center 110 solely via power generation system 208 when the price(s) of primary power source power 206A, 206B exceeds the threshold switching price.

A method for powering data center 110 to transition from the first condition shown in FIG. 3 to the second condition shown in FIG. 4 can include powering a data center 110 via power from one or more primary power sources 206A, 206B and powering an interruptible computing load container 120 comprising interruptible DCUs (e.g., cryptocurrency miners and/or cloud computing resources) via an electrical power generation system 208. The method includes, upon determining that a power price associated with power from the one or more primary power sources 206A, 206B exceeds a threshold price, electrically decoupling the electrical power generation system 208 from the interruptible computing load container 120, electrically decoupling the one or more primary power sources 206A, 206B from the data center 110, and powering the data center 110 by the electrical power generation system 208 (e.g., via electrically coupling the electrical power generation system to the data center 110).

A method for powering data center 110 to transition from the first condition shown in FIG. 3 to the third condition shown in FIG. 5 can include powering the data center 110 by power generated from one or more primary power sources 206A, 206B and powering the interruptible computing load container 120 by the electrical power generation system 208. The method then includes, upon determining that the price of power generated from the one or more primary power sources 206A, 206B exceeding a predetermined price threshold: electrically decoupling the electrical power generation system 208 from the interruptible computing load container 120, electrically decoupling the one or more primary power sources 206A, 206B from the data center 110, powering the data center 110 by the electrical power generation system 208, and selling excess power generated by the electrical power generation system 208 to the grid 206B.

In one specific embodiment, the system may comprise a 500 kW IT-load data center 110 with a total power requirement of about 1 MW. In this case, the electrical power generation system 208 may be configured to generate at least about 1 MW. Similarly, the interruptible computing load container 120 may comprise consumers with a total power requirement of less than or equal to the power generation capacity of the electrical power generation system 208.

In another specific embodiment, the system may comprise a 64 MW IT-load data center 110 with a total power requirement of about 96 MW. In this case, the electrical power generation system 208 may be configured to generate at least about 96 MW and the interruptible computing load container 120 may similarly be designed to have a total power requirement of less than or equal to the power generation capacity of the electrical power generation system 208.

### Exemplary Power Management Systems

FIG. 7 illustrates a first exemplary data center power management system 700, which may be operated in accordance with the methods described above with respect to in FIGS. 3 to 5. As shown, system 700 includes a plurality of power sources, including at least one primary power source 702A, 702B, at least one secondary power source 704, and an optional backup power source 720. Generally, such power sources are provided to power one or more data centers comprising cloud DCUs 718 (e.g., GPUs, CPUs, etc. for providing cloud services), one or more interruptible load containers comprising interruptible DCUs 716 (e.g., cryptocurrency miners and/or processors for providing “spot” or “preemptible” cloud services), and other components associated with such power consumers (e.g., networking, cooling, monitoring and control equipment, etc.).

In one embodiment, the at least one primary power source may comprise a first primary power source in the form of a renewable energy source 702A and a second primary power source in the form of electric grid 702B. As discussed above, when multiple primary power sources are present, the system may be configured to automatically utilize power from a particular primary power source based on a respective power price, contractual provisions, and/or third-party requirements (e.g., utility operator or government regulations). Additionally or alternatively, a primary power source may be manually selected by such selection may be enforced by a third party.

The secondary power source may comprise one or more power generation modules 704, such as turbines and/or generators adapted to convert a fuel source (e.g., natural gas, NGLs, diesel, etc.) into electrical power. In some embodiments, the secondary power source 704 may be in communication with a carbon capture system 706 adapted to receive exhaust generated by power generation module 704 and remove carbon therefrom.

In the example of FIG. 7, both of renewable energy source 702A and electric grid 702B have a first output voltage of 34.5 kV, while power generation module 704 has a second output voltage different from the first voltage of 13.8 kV. Accordingly, the electrical output of power generation module 704 may be fed into a step-up transformer 708, which increases the second voltage from 13.8 kV to 34.5 kV to match the first voltage. The electrical output of step-up transformer 708 is fed into a common electrical bus 710 along with the electrical output of renewable energy source 702A or electric grid 702B at the same voltage as sources 702A, 702B. In other words, common electrical bus 710 may receive power output by any or all of the primary 702A, 702B and secondary 704 power sources at the same voltage for distribution to consumers 716, 718.

As shown, the common electrical bus 710 may be in electrical communication with one or more step-down transformers 712, 714, which in-turn, are in electrical communication with the consumers 716, 718. For example, the common electrical bus 710 may provide power at 34.5 kV, which is not suitable to directly power the consumers. Accordingly, the one or more step-down transformers may be employed to receive power from the common electrical bus, reduce the voltage to a suitable voltage for powering the respective consumers 716, 718, and provide the reduced voltage power to respective consumers.

In the illustrated embodiment, both a first step-down transformer 712 and a second step-down transformer 714 are employed. The first step-down transformer 712 steps down the voltage from 34.5 kV to a suitable voltage for powering interruptible DCUs 716 (e.g., 415 V). And the second step-down transformer 714 steps down the voltage from 34.5 kV to a voltage suitable for powering DCUs 718 providing cloud service to remote client computers (e.g., 480 V or 415 V). Although not shown, it will be appreciated that exemplary embodiments may comprise various power distribution and/or conditioning equipment in communication with the transformer(s) 712, 714 and the respective consumers 716, 718.

As discussed above with respect to FIGS. 3 to 5, situations may occur wherein power from the one or more primary power sources 702A, 702B is unavailable or uneconomical. In such instances, a power switching system may direct power away from the interruptible computing load consumers 716 in favor of the data center consumers 718. More particularly, at least a portion of the interruptible computing load consumers 716 may be powered down or off such that some or all of the power from the secondary power source 704 can be routed to the data center consumers 718 via the common electrical bus 710 and the first step-down transformer 714.

It will be appreciated that the system 700 may further comprise a backup power system 720 to ensure the data center consumers 718 continue running in the event both the primary and secondary power sources fail. In one embodiment, the backup power system 720 comprises a battery and/or a diesel generator. The battery may be employed to power the data center consumers while the diesel generator is started up; and the backup power system may transition from the battery once the generator is running.

As shown, a manual transfer switch (MTS) 722 is provided downstream of backup power system 720 to allow for switching between a load bank 723 and an automatic transfer switch (ATS) 724. The load bank 723 receives and dissipates any electricity generated by backup power system 720 that is not used by consumers 716, 718 (e.g., for emissions testing of backup power system). Both second step-down transformer 714 and MTS 722 feed into ATS 724, allowing ATS 724 to automatically switch over from power provided by sources 702A, 702B or 704 via transformer 714 to power provided by backup power system 720 in the event that the power supply from renewable energy source 702A or electric grid 702B or power generation module 704 suddenly becomes unavailable.

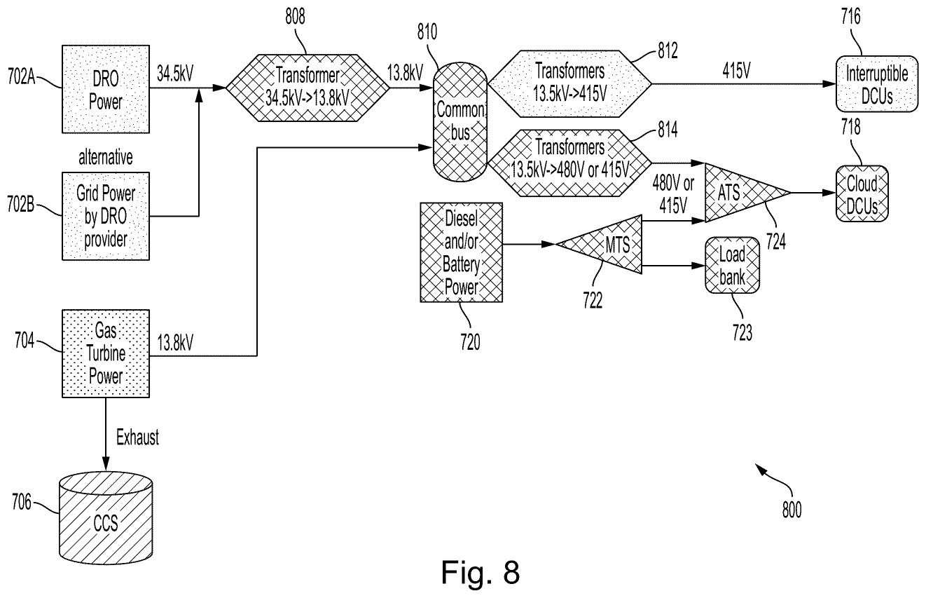

FIG. 8 shows a second exemplary data center power management system 800, which may be operated in accordance with the methods of FIGS. 3 to 5. System 800 is configured in the same manner as system 700, except that: system 800 omits step-up transformer 708 and includes a step-down transformer 808 directly downstream of the one or more primary power sources 702A, 702B; and step-down transformers 712, 714 and common electrical bus 710 are respectively replaced by step-down transformers 812, 814 and common electrical bus 810.

The electrical output of primary power sources 702A, 702B is fed directly into step-down transformer 808, which steps down the voltage from power sources 702A, 702B from 34.5 kV to 13.8 kV prior to being fed into common electrical bus 810. The electrical output of power generation module 704 is fed directly to common electrical bus 810 at the same 13.8 kV voltage. Accordingly, common electrical bus receives power output by each of the power sources 702A, 702B, 704 at the same voltage of 13.8 kV for distribution to consumers 716. Common electrical bus 810 outputs power at 13.8 kV to both the first step-down transformer 812 and second step-down transformer 814. The first step-down transformer 812 steps down the voltage from 13.8 kV to 415 V for powering interruptible DCUs 716. The second step-down transformer 814 steps down the voltage from 13.8 kV to 480 V or 415 V for powering GPUs 718 providing cloud service to remote client computers.

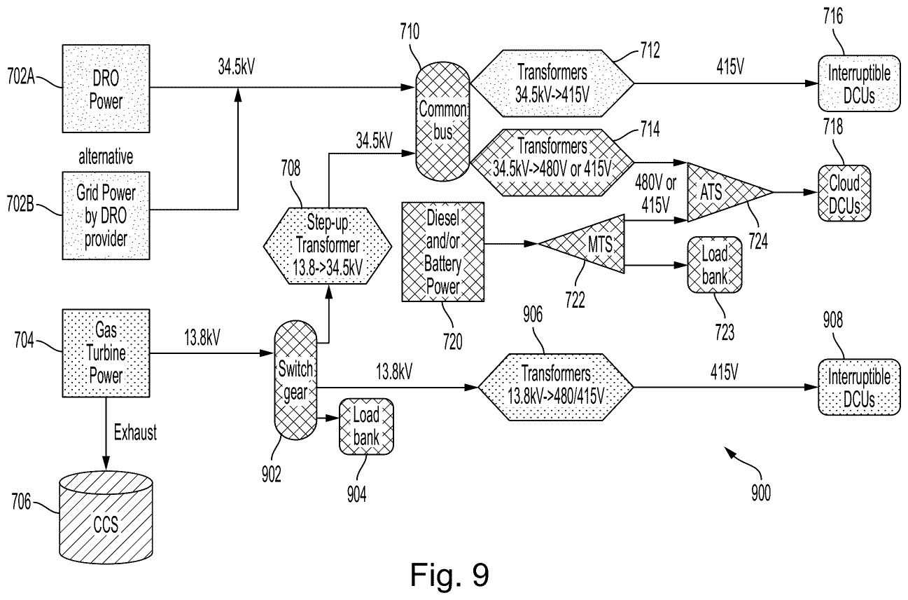

FIG. 9 shows a third exemplary data center power management system 900, which may be operated in accordance with the methods of FIGS. 3 to 5. System 900 is configured in the same manner as system 700, except that system 900 includes additional components in the form of switchgear 902, a further load bank 904, a third step-down transformer 906 and an additional interruptible computing load (interruptible DCUs 908).

Switchgear 902 is configured to switch the electrical output of power generation module 704 to step-up transformer 708, step-down transformer 906 or load bank 904. Switchgear 902 can switch from providing power to interruptible DCUs 908 via step-down transformer 906 to providing power to power interruptible DCUs 716 and cloud DCUs 718 via step-up transformer 708 if the active power source 702A or 702B loses power, if the price of power for the active power source is greater than the price of power for power generation module 704, or if the power requirement (i.e., total load) for interruptible DCUs 716 and cloud DCUs 718 is greater than what can be supplied from the active primary power source 702A or 702B.

During normal operation, when the selected primary power source 702A or 702B is available and below a determined cost threshold, the primary power source 702A or 702B can power both interruptible DCUs 716 and cloud DCUs 718 and power generation module 704 can power interruptible DCUs 908. Specifically, during normal operation, switchgear 902 can direct the electrical output of power generation module 704 to step-up transformer 708. In other words, when the electrical output of power generation module 704 is delivered by switchgear 902 to step-down transformer 906, power output by power generation module 704 powers interruptible DCUs 908. The primary power sources 702A, 702B power cloud DCUs 718 and interruptible DCUs 716 when the electrical output of power generation module 704 is delivered by switchgear 902 to step-down transformer 906.

When the electrical output of power generation module 704 is delivered by switchgear 902 to step-up transformer 708, power output by power generation module 704 powers at least cloud DCUs 718 and, if the power delivered to the common bus 710 exceeds the power required by cloud DCUs 718, possibly at least some of interruptible DCUs 716. It will be appreciated that the primary power sources 702A, 702B are not providing power to GPUs 718 and interruptible DCUs 716 when the electrical output of power generation module 704 is delivered by switchgear 902 to step-up transformer 708. That is, the system will switch to such configuration upon determining that the primary power sources 702A, 702B are not available (or are not economically viable) to power the cloud DCUs 718.

When the electrical output of power generation module 704 is delivered by switchgear 902 to load bank 904 or interruptible DCUs 908, the primary power sources 702A, 702B provide power to GPUs 718 and interruptible DCUs 716.

In another example, switchgear 902, load bank 904, transformer 906 and interruptible DCUs 908 can be added to system 800 in FIG. 8 between power generation module 704 and common bus 810.

FIG. 10 shows a fourth exemplary data center power management system 1000 including components that can be employed to achieve the system in FIG. 11. System 1000 is configured in the same manner as system 800, except that system 1000 omits power sources 702A, 702B and step-down transformer 808. The power generation module 704, which in the same manner as in FIG. 11 can be two or more power generation modules synced together at the common bus 810, forms the primary power source due to the omission of power sources 702A, 702B.

The electrical output of power generation module 704 is provided to common electrical bus 810 at a voltage of 13.8 kV. Common electrical bus 810 outputs power at 13.8 kV to both the first step-down transformer 812 and second step-down transformer 814. The first step-down transformer 812 steps down the voltage from 13.8 kV to 415 V for powering interruptible DCUs 716. The second step-down transformer 814 steps down the voltage from 13.8 kV to 480 V or 415 V for powering cloud DCUs 718, which may be configured to provide cloud services to users of remote client devices. Accordingly, power generation module 704 powers both the cloud DCUs 718 and interruptible DCUs 716.

In a similar manner as in FIGS. 7 to 9, system 1000 includes a backup power source 720, which can be a diesel generator or a battery, for providing power to cloud DCUs 718 if power from power generation module 704 becomes suddenly unavailable.

### Load Balancing Power Consumption System

FIG. 11 shows an exemplary data center power management system 1100 including power consumption system 1103 and a power production system 1105. It will be appreciated that the power management system 1100 may include all of the components shown in FIG. 1 and/or some or all of the components of system 1000 shown in FIG. 10; the illustrated embodiment provides a simplified schematic showing only power consumption system 1103 and power production system 1105.

As shown, the power production system 1105 includes a first power generation module 1104a and a second power generation module 1104b. Power generation modules 1104a, 1104b can be configured in a similar manner to power generation modules 631a, 631b of FIG. 6, and can receive a continuous stream of natural gas from a natural gas pipeline. In the example shown in FIG. 11, each of power generation modules 1104a, 1104b is a turbine having a power generation capacity of 14 MW. In the same manner as in FIG. 10, turbines 1104a, 1104b can output power at a voltage of 13.8 kV to a common electrical bus 1110, which can alternatively be a microgrid, and system 1100 can include step-down transformers downstream of common bus 1110 that reduce the voltage from 13.8 kV to an appropriate voltage (480 V or 415V) for inputting into the power consumers of power consumption system 1103.

As illustrated in FIG. 11, the power consumers of production system 1105 can include a data center 1112 configured for consuming all of the power generated by power generation module 1104a and a primary interruptible computing load 1116 configured for consuming all of the power generated by power generation module 1104b. Data center 1112 includes DCUs 1113 (i.e., GPUs and/or CPUs) for providing cloud services, auxiliary devices 1114 for conditioning data center 1112, and a secondary interruptible computing load 1118 configured for consuming any power generated by power generation module 1104a that is in excess of that consumed by DCUs 1113 and auxiliary devices 1114. It will be appreciated that each of interruptible computing loads 1116, 1118 can include interruptible DCUs (e.g., cryptocurrency miners and/or processors for providing “spot” or “preemptible” cloud services), and other components associated with such power consumers (e.g., networking, cooling, monitoring and control equipment, etc.).

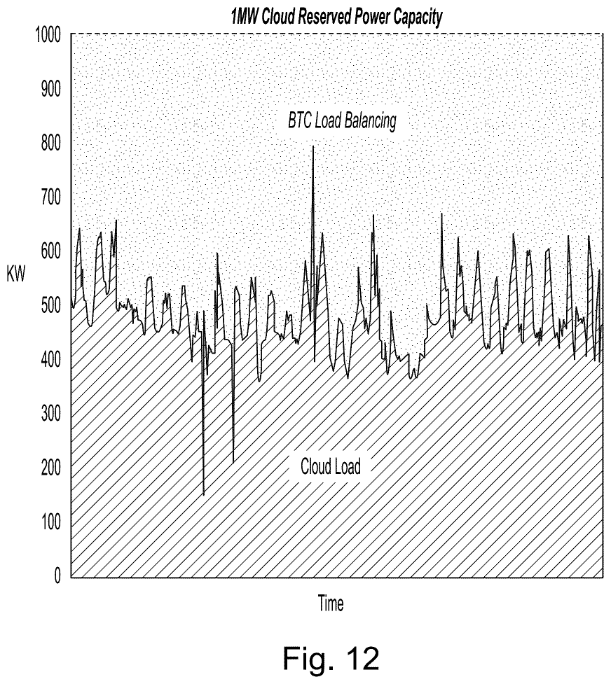

In the example illustrated in FIG. 11, DCUs 1113 collectively have a rated power consumption of 10 MW, which means that DCUs 1113 collectively consume 10 MW when the DCUs 1113 are all operating at maximum power capacity. In other words, the DCUs 1113 have a rated power consumption defined by a cumulative sum of the maximum power consumptions of the DCUs 1113. However, the DCUs 1113 are configured for consuming variable power during operation and it is extremely rare that all of the DCUs 1113 would be operating at maximum power consumption at the same time. Normally, as illustrated in FIG. 12, the power consumption by DCUs 1113 is between 40% and 60% of the collective rated power consumption of DCUs 1113. Auxiliary devices 1114 include an HVAC system for temperature control of data center 1112, and can include a lighting system and/or a fire detection system of data center 1112. FIG. 12 illustrates an example of a power usable by DCUs 1113 having a collective rated power consumption of 1 MW over a month. As illustrated, the data consumption by DCUs 1113 never reaches 1 MW, but varies between a minimum of approximately 120 KW and a maximum of 800 KW, and a majority of the time is between 400 KW and 600 KW. The operator of data center 1112 would still need to have sufficient available power to match the rated power consumption of the DCUs 1113, in the event that all of the cloud client computers are simultaneously engaged in power intensive activities, for example training machine learning algorithms.

Referring back to FIG. 11, by providing secondary interruptible computing load 1118, power management system 1100 can provide sufficient available power to match the rated power consumption of the DCUs 1113, and minimize wasting or underutilizing power generated by power generation module 1104a. Power management system 1100 further includes a carbon capture system 1120 receiving exhaust gas from both of power generation modules 1104a, 1104b to make power management system 1100 environmentally friendly. To achieve economic viability for carbon capture system 1120, it is advantageous if power generation modules 1104a, 1104b operate at as close to maximum operating power as possible to generate sufficient exhaust gas during a predetermined time period, for example a year. The power redundancy offered by using at least two power generation modules 1104a, 1104b can thus advantageously ensure that client computers utilizing DCUs 1113 of data center 1112 do not experience an interruption of service, while additionally allowing the operator of power management system 1100 to generate revenue for all of the power produced by power generation modules 1104a, 1104b and provide sufficient exhaust gas to the carbon capture system 1120.

A monitoring and control system 1122 of power management system 1100 is configured to receive metrics of the power generation modules 1104a, 1104b and receive real-time power consumption metrics for the DCUs 1113 that are configured for consuming variable power during operation. The monitoring and control system 1122 is also configured to output a control signal to vary a power consumption of the DCUs of the interruptible computing loads 1116, 1118 based on a difference between the real-time power consumption metrics for the DCUs 1113 and the rated power consumption of the DCUs 1113. The monitoring and control system 1122 can also be configured to control power consumed by the interruptible computing loads 1116, 1118 to achieve a predetermined electrical consumption that is a minimum threshold required by the carbon capture system 1120.

Specifically referring to the example in FIG. 11, and for exemplary purposes assuming each power generation modules 1104a, 1104b is always producing exactly 14 MW of power, primary interruptible computing load 1116 is configured to consume all 14 MW of power produced by power generation module 1104b and auxiliary devices 1114 are configured to consume 4 MW of power produced by power generation module 1104a. This leaves 10 MW of power produced by power generation module 1104a for consumption by DCUs 1113 and secondary interruptible computing load 1118 together. The monitoring and control system 1122 can vary the power consumption of secondary interruptible computing load 1118 in response to the varying power consumption of DCUs 1113 such that the power consumption of secondary interruptible computing load 1118 equals the rated power consumption of DCUs 1113 minus the actual current power consumption of DCUs 1113. Accordingly, as if shown in FIG. 11, the actual current power consumption of DCUs 1113 is 4 MW, because the rated power consumption of DCUs 1113 is 10 MW, monitoring and control system 1122 controls secondary interruptible computing load 1118 to have a power consumption of 6 MW.

If both of interruptible computing loads 1116, 1118 include cryptocurrency miners, the miners of interruptible computing load 1116 can be considered a first subset of miners and the miners of interruptible computing load 1118 can be considered a second subset of miners. The interruptible computing load 1116 can include more profitable cryptocurrency miners (e.g., miners having a higher average hashrate per unit of energy consumed) than the cryptocurrency miners of interruptible computing load 1118. Accordingly, the less profitable miners of the interruptible computing load 1118 can be turned on and off by monitoring and control system 1122 in response to the variable power consumption by the DCUs 1113, while monitoring and control system 1122 refrains from varying the power consumption of the more profitable miners of interruptible computing loads 1116.

Where auxiliary devices 1114 comprise an HVAC system, the monitoring and control system 1122 can also be configured to receive metrics of the HVAC system and output a control signal to vary the power consumption of the interruptible computing loads 1116, 1118 based on a difference between the real-time power consumption metrics for the DCUs 1113 and the rated power consumption such DCUs 1113, and based on real-time power consumption metrics for the HVAC system.

In the event of the failure of one of the power generation modules 1104a, 1104b or if one of the power generation modules 1104a, 1104b is shut down for maintenance, some or all of the DCUs of the primary interruptible computing load 1116 can be powered off so that the remaining power generation module 1104a, 1104b powers at least DCUs 1113 and auxiliary load 1114, and optionally interruptible computing load 1118. If the operating power generation module 1104a or 1104b produces enough power to fully power DCUs 1113, auxiliary load 1114 and interruptible computing load 1118, the operating power generation module 1104a or 1104b can also power some or all of the DCUs of interruptible computing load 1116.

In another embodiment, interruptible computing load 1118 can be omitted and the DCUs of interruptible computing loads 1116 can be configured to run firmware that allows the power consumption of DCUs of interruptible computing loads 1116 to be increased beyond the respective rated power consumption of each DCU. For example, assume power generation module 1104b is configured to output a maximum power of 14 MW and, as noted above with respect to FIG. 12, and at least 40% (i.e., 4 MW in FIG. 11) of the rated power consumption of DCUs 1113 is available approximately 95% to 99% of the time during a predetermined time period. If for this example the DCUs of interruptible computing loads 1116 are cryptocurrency miners, a container for interruptible computing loads 1116 can be provided with DCUs that cumulatively have a rated power consumption of 18 MW, allowing all of the DCUs to operate at the respective rated power consumption when power generation modules 1104a, 1104b is operating at the maximum power output. Assuming maximum power production of 14 MW by both power generation modules 1104a, 1104b, the DCUs of interruptible computing loads 1116 can then be operated above the respective rated power consumption of each DCU (i.e., the miners are overclocked) when the power consumption of DCUs 1113 is below 6 MW, and the DCUs of interruptible computing loads 1116 can be operated below the respective rated power consumption of each DCU (i.e., the miners are underclocked) when the power consumption of DCUs 1113 is above 6 MW.

### Power Control Algorithms

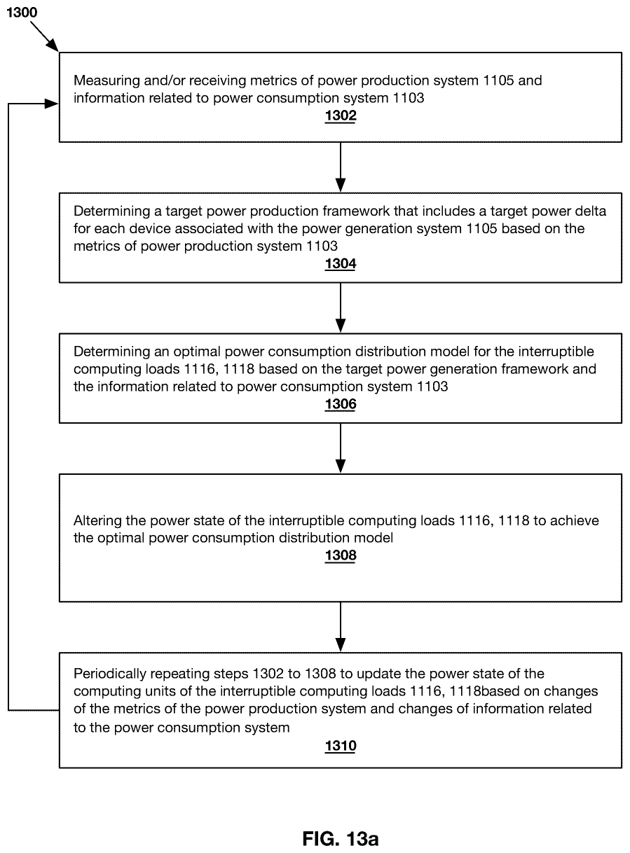

FIG. 13a illustrates a power control method 1300 of dynamically controlling a supply of power to power consumption system 1103 powered by a power production system 1105. Method 1300 first includes a step 1302 of measuring and/or receiving metrics of the power production system 1105 and metrics of a power consumption system 1103. Step 1302 can also include receiving real-time power consumption metrics for the DCUs that are configured for consuming a variable power and are unavailable due to a third party service directive (i.e., DCUs of consumer object 1412c, which as noted above can correspond to DCUs 1113 in FIG. 11).

Method 1300 further includes a step 1304 of determining a target power production framework that includes a target power delta for each of a plurality of devices associated with the power production system 1105, the target power deltas being based on the metrics of power production system 1105. This step 1304 can include receiving real time metrics for each of the devices of power production system 1105. Devices of power production system 1105 can include the power generation modules 1104a, 1104b. Referring to FIG. 10, the devices can also include step-down transformers 812, 814. Other devices of power production system 1100 can include a compressor/engine assembly for providing compressed natural gas to power generation modules 1104a, 1104b, or devices that monitor parameters that impact the production and/or delivery of power to the consumers (i.e., to DCUs 1113 and interruptible computing loads 1116, 1118 and to auxiliary devices 1114). The devices that monitor parameters that impact the production and/or delivery of power to the consumers can include a pressure sensor 674 (FIG. 6) or a gas flow meter used in place of pressure sensor 674. In other words, the devices of power production system 1105 are devices that impact the power supply by system 1105 or monitor variables impacting the power supply by system 1105. A compressor can also be included upstream of power generation modules 1104a, 1104b to compress the gas before the gas is delivered to power generation modules 1104a, 1104b, and the devices that monitor parameters can be both a first pressure sensor or flow meter upstream from the compressor, and a second pressure sensor or flow meter downstream from the compressor.

As part of substep 1304 of method 1300, referring together to FIGS. 1, 2, 6, 10 and 11, the leader power control module 114d, when executed by the processor 114a, can cause the processor 114a to, as part of the step (a), fetch real time metrics for each of the devices of power production system 1105 and for each of the consumer objects. The leader power control module 114d can fetch data originating from the sensors of power production system 1105, e.g., from sensors 670, 674, 676 (FIG. 6), on a site, and from the orchestrators 114c, 124c, fetching all metrics for power production and consumption for the site. The metrics can be fetched at predetermined internals, such as every 1 to 60 seconds. The metrics for each of the consumer objects of power consumption system 103 fetched from orchestrators 114c, 124c can include a current power, a minimum power, a maximum power and a utility value for each consumer object.

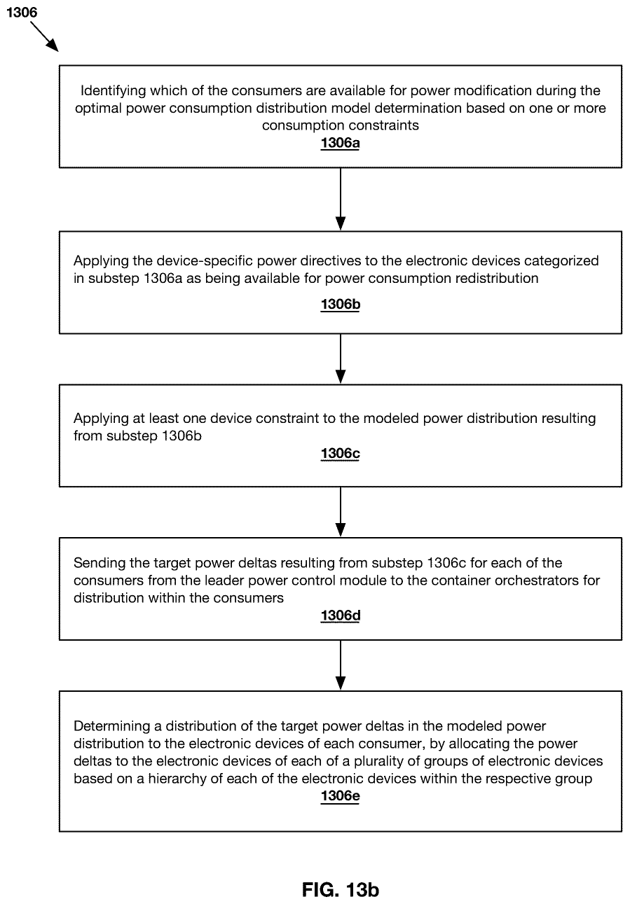

FIG. 14 schematically shows a simplified power consumption distribution model 1400 and helps to illustrate the substeps of step 1306. Model 1400 includes a consumer section 1400a and a producer section 1400b and visualizes the relationship of devices of an exemplary power production system and an exemplary power consumption system for a site.

Section 1400a illustrates consumer objects 1412a to 1412e, which can each represent a group of DCUs, and containers 1414a to 1414 housing the DCUs represented by consumer objects 1412a to 1412e. DCUs represented by consumer objects 1412a, 1412b are housed within container 1414a, DCUs represented by consumer objects 1412c is housed within container 1414b, DCUs represented by consumer objects 1412d is housed within container 1414c and DCUs represented by consumer objects 1412e are housed within container 1414d. Each consumer object 1412a to 1412e can represent a group of computing units having a similar profile. For example, consumer objects 1412a, 1412b in container 1412a can each includes a group of cryptocurrency miners having a similar profile, with consumer object 1412a including only cryptocurrency miners of a first model or a first set of models having a hashrate per unit of energy consumed within a predetermined range, and consumer object 1412b including only cryptocurrency miners of a second model different from the first model or a second set of models having a hashrate per unit of energy consumed in a predetermined range that is different from the predetermined range of the first set of models. As another example, consumer object 1412e can include only GPUs providing cloud services to third parties and have been deemed uninterruptible and having an energy priority over all other consumer objects.

Section 1400b illustrates devices in the form of transformers 1416a to 1416c, generators 1418a to 1418c, and an inlet pressure sensor 1420.

In relation to substep 1306a, consumer objects 1412c to 1412e are categorized as being unavailable for power consumption redistribution in model 1400 under different consumer constraint directives. Consumer object 1412c is categorized as unavailable due to a third party service directive because consumer object 1412c represents DCUs providing cloud services to remote client computers (i.e., consumer object 1412c can correspond to DCUs 1113 in FIG. 11). Consumer object 1412d is categorized as unavailable due to a constant power directive. Consumer object 1412e is categorized as unavailable due to a positive power delta directive.

As part of a step 1304 of method 1300, the power control module 114 and/or 124, when executed by the processor 114a and/124a, can cause the processor 114a and/or 124a to, as part of the step 1304, calculate a target power delta for each of the metrics; for each of the devices of power production system 1105 for which more than one target power delta is calculated, select a minimum target power delta from amongst the target power deltas for the device as the selected target power delta for the device; and for each of the devices of power production system 1105 for which only a single target power delta is calculated, selecting the single target power delta as the selected target power delta for the device.

Each of the different target power deltas is based on a different energy producer metric. Step 1304 can include running each of the metrics through a distinct PID (Proportional-Integral-Derivative) controller to determine a target power for each of the metrics. For example, referring to the above-described devices, each power generation metric, each transformer metric and each site metric can be run through a distinct PID controller to determine a distinct target power delta for each distinct power generation metric, each distinct transformer metric and each distinct site metric. Power control modules 114d, 124d can run all of the PID controllers simultaneously to generate the target power deltas for each metric.

A target power delta is then selected for each device from the calculated different target power deltas. For each of the devices for which more than one target power delta is calculated, step 1304 includes selecting a minimum target power delta from amongst the target power deltas for the device as the selected target power delta for the device. For each of the devices for which only a single target power delta is calculated, step 1304 includes selecting the single target power delta as the selected target power delta for the device

For example, as shown below in Table 3, if the target power delta for the engine pressure is +10 KW, the target power delta for the generator output is −5 KW, the target power delta for the engine output is −15 KW, the target power delta for the coolant temperature is +20 KW, the target power delta for the percent engine load is +30 KW, the target power delta for the cylinder positions of the engine is −10 KW, and the target power delta for the knock index is +15 KW, then the target power delta for the engine output is the minimum target power delta, and −15 KW is the selected power delta for the power generation module 1104a, 1104b. This conservative approach can advantageously prevent shutdowns power generation modules 631 of power production system 1105 while maximizing the operating production of DCUs 112, 114 as a whole.

TABLE 3

| Power Generation Metric | Target power delta |
|---|---|
| engine pressure | +10 KW |
| generator output | −5 KW |
| engine output | −15 KW |
| coolant temperature | +20 KW |
| percent engine load | +30 KW |
| cylinder positions of the engine | −10 KW |
| knock index | +15 KW |
| minimum generator target power delta | −15 KW |

If only a single metric is analyzed for one of devices, such as for example only the temperature for a step-down transformer (e.g., FIG. 8 at 812, 814) or only the pressure of entry gas for a gas supply line (e.g., FIG. 6 at 620), then the target power delta for said single metric is selected as the target power delta for the respective device 812, 814 or 620.

A next step 1306 comprises determining an optimal power consumption distribution model for the computing units 112, 122 based on the target power production framework and the metrics related to power consumption system 103. The optimal power consumption distribution model can take into account a varying power consumption of the first computing units (e.g., DCUs 1113) and the varying consumption of the auxiliary devices 1114 to vary a power consumption of the second computing units (i.e., DCUs of the interruptible computing loads 1116, 1118). In other words, the power consumed by DCUs of the interruptible computing loads 1116, 1118 are adjusted in response to the optimal power produced by power production system 1105 and the power consumed by DCUs 1113 and the auxiliary devices 1114.

For example, if the optimal power produced by power production system 1105 remains constant, and there is an increase in power consumption by DCUs 1113 and/or the auxiliary devices 1114, the power consumption of interruptible computing loads 1116 and/or 1118 is decreased to compensate for the increase in power consumption by DCUs 1113 and/or the auxiliary devices 1114. If the optimal power produced by power production system 1105 remains constant, and there is an decrease in power consumption by DCUs 1113 and/or the auxiliary devices 1114, the power consumption of interruptible computing loads 1116 and/or 1118 is increased to compensate for the decrease in power consumption by DCUs 1113 and/or the auxiliary devices 1114. Also, if the optimal power produced by power production system 1105 increases, but the power consumption of DCUs 1113 and/or the auxiliary devices 1114 remains constant, the power consumption of interruptible computing loads 1116 and/or 1118 is increased to compensate for the increase in optimal power production by power production system 1105. If the optimal power produced by power production system 1105 decreases, but the power consumption by DCUs 1113 and/or the auxiliary devices 1114 remains constant, the power consumption of interruptible computing loads 1116 and/or 1118 is decreased to compensate for the decrease in optimal power production by power production system 1105. If both the optimal power produced by power production system 1105 power consumption by DCUs 1113 and/or the auxiliary devices 1114 vary, the power consumption of at least one of interruptible computing loads 1116 and/or 1118 is varied to compensate for the net variance.

As discussed in further detail below, the optimal power consumption distribution model takes into consideration power directives associated with the devices of power production system 1105 along with constraints of at least one of said devices, and selects DCUs of interruptible computing loads 1116, 1118 for achieving the optimal power consumption distribution model. Each of the power directives is device-specific and takes into account the selected target power delta for the device.

In one advantageous example that helps to maximize the use of computing resources without causing operational problems of power production system 1105, as described in further detail below, step 1306 involves considering the selected target power delta for each device individually as a device-specific power directive, and then applying the device-specific power directive in the optimal power consumption distribution model determination to a set of the computing units, which can be represented together by a consumer object, associated with the respective device. By associated with, it is meant that the device impacts the power supply to the computing unit or monitors variables impacting the power supply to the computing unit. A device impacting the power supply can be any device involved in the production of power that is supplied to the computing unit, or any device involved in the delivery of this generated power to the computing unit. A device that monitors variables impacting the power supply to the computing unit can be any sensor measuring parameters of fuel delivered to a power production device or measuring parameters in the production or delivery of the power supplied to the computing unit.

The determination of the optimal power consumption distribution model can involve applying a series of power directives that are each capable of altering a previously applied power directive if the modeled power consumption distribution of the previously applied power directive(s) does not comply with the current power directive. Power constraints of at least one of the devices can also limit the power directive to constrain the modeled power consumption distribution. In one example, the device-specific power directives are first applied in a first calculation pass to output a modeled power consumption distribution, then the at least one device power constraint is applied to the modeled power consumption distribution resulting from the first calculation pass in a second calculation pass to output the optimal power consumption distribution model. This order of operations provides more flexibility, as applying the at least one device power constraint prior to the power directives would more strictly limit the optimal power consumption distribution model.

In particular, this step 1306 includes a plurality of substeps illustrated in FIG. 13b. A first substep 1306a includes identifying which of the consumer objects are available for power modification during the optimal power consumption distribution model determination based on one or more consumption constraints. Consumer objects can be categorized as unavailable according to different consumer constraint directives. Consumer objects can represent a group of DCUs that are categorized together based on one or more characteristics. In an advantageous example, the characteristic used to categorize DCUs into a group is a utility value of each of the DCUs. As discussed below, the utility value can represent a monetary value of operating the DCU in comparison to power consumption, or a predetermined range of the monetary value of operating the DCU in comparison to power consumption. More specifically, the utility value can be the revenue or profit generated by the DCU per unit of energy, such as dollar per KWh or joules. For DCUs, the utility can be based on the model of the DCU, as DCUs of the same model have the same or approximately the same (+/−10%) monetary value of operating the DCU in comparison to power consumption.

The availability status of the consumer object can be represented in the respective controller memory 114b, 124b. The availability status can be input into a human machine interface of computing unit in communication with control system 101 and stored in business database 148. Upon one of power control modules 114d, 124b being elected as the leader, the consumer object availability statuses can be pushed from business database 148 by coordinator 130 to the leader, then stored in the respective memory 114b, 124b, and is retrieved from the controller memory 114b, 124b by the respective power control module 114d, 124d in substep 1306a.

In substep 1306a, consumer objects that represent computing units used to provide services to third parties can be categorized as unavailable due to a third party service directive. In the embodiment of FIG. 11, the DCUs 1113 are categorized as unavailable as these DCUs 1113 have an energy priority over the DCUs of interruptible computing loads 1116, 1118. As noted above, while interruptible computing loads 1116, 1118 can include DCUs that provide cloud services to remote client computers, these DCUs are categorized as available for power modification because these DCUs have an energy priority below the DCUs 1113 and the customers have agreed to possible interruptions in exchange for lower pricing. The power consumption of the DCUs 1113 is dictated by computing operations being performed by the third parties, and power deltas are not distributed to the consumer objects representing these computing units by the power directives or by the at least one device power constraint.

Other consumer objects can be categorized as unavailable due to a constant power classification. These consumer objects are assigned a constant power and are unavailable for any power delta, and can be completely excluded from the optimal power consumption distribution model determination.

Further, consumer objects can be categorized as unavailable due to a positive power delta directive or a negative power delta directive. These consumer objects are assigned a positive constant power delta or a negative constant power delta that is applied to the optimal power consumption distribution model determination. A positive power delta directive can be initiated by an on-site maintenance worker who needs to power up a container of computing units back on after a maintenance operation and has determined that such a power up operation will not damage any device of the power system. A negative power delta directive can be initiated by an on-site maintenance worker who needs to power down a container of computing units for a maintenance operation and has determined that such a power down operation will not damage any device of the power system.

Consumer objects representing auxiliary devices 1114 can also be categorized as unavailable. For example, where auxiliary devices 1114 are or include an HVAC system, the power consumption of the HVAC system is dictated by the ambient temperature and the predetermined temperature range inside the data center 1112, and is not modifiable in the method 1300. The power consumption of the HVAC system can still be measured and taken into account by the monitoring and control system for varying the power consumption of the interruptible computing loads 1116, 1118. Accordingly, an increase in power consumption of the HVAC system can result in the decrease of the power consumption of the interruptible computing loads 1116, 1118, and a decrease in power consumption of the HVAC system can result in the increase of the power consumption of the interruptible computing loads 1116, 1118.

Consumer objects that are not categorized as unavailable for power consumption redistribution in the optimal power consumption distribution model determination, are categorized as available for power consumption redistribution in the optimal power consumption distribution model determination.

A next substep 1306b in the optimal power consumption distribution model determination is applying the device-specific power directives to the computing units categorized in substep 1306a as being available for power consumption redistribution. In the embodiment of FIG. 11, the DCUs of the interruptible computing loads 1116, 1118 are the computing units categorized as being available for power consumption redistribution.

The power directives can include a first power directive distributing the selected power delta for a first device of power production system 1105 to at least one available consumer object whose power supply is impacted that monitor parameters that impact the production by the first device and/or delivery of power by the first device. In other words, the first power directive distributes the selected target power delta for the first device to a first set of the computing units. The first set of the computing units are those which are associated with the first device and which are available for inclusion in the modeled power consumption distribution.

The first device can for example be generator 1418a in FIG. 14, and the first power directive can be based for example on the example discussed with respect to step 1304 and shown above in Table 3, where the target power delta for the engine output is the minimum target power delta, and −15 KW is selected as the target power delta for the generator 1418a.

The first power directive can be distributed on a consumer object-by-consumer object basis, so the −15 KW power delta is distributed to consumer objects 1412a, 1412b, without it being determined how the target power delta is distributed on a computing unit-by-computing unit basis. In this example, container 1414a includes two consumer objects 1412a, 1412b and each of containers 1414b to 1414d includes a single respective consumer object 1412c to 1412e. In other examples, there can be more than two or more groups of DCUs per container, or a single group of DCUs can include the computing units of two or more containers, with each group represented by a respective consumer object. Each consumer object 1412a to 1412e can include tens or hundreds of computing units.

Although the production of power to consumer objects 1412a to 1412d in containers 1414a to 1414c is impacted by (here generated by) generator 1418a, consumer objects 1412c, 1412d can be categorized as unavailable for power consumption redistribution in model 1400, and thus only consumer objects 1412a, 1412b of container 1414a are available for power consumption redistribution in model 1400. The computing units represented by consumer objects 1412a, 1412b would thus be the first set of the computing units as they are associated with the first device and are available for inclusion in the modeled power consumption distribution. Referring to FIG. 11, the power control modules 1104a, 1104b are considered together since modules 1104a, 1104b are synced together by a common electrical bus 1110 that generates a single electrical output. As noted above, consumer object 1412c is categorized as unavailable due to a due to a third party service directive and consumer object 1412d is categorized as unavailable due to a constant power directive (i.e., target power delta is 0). For example, if the third party service power delta directive requires a target power delta of +5 KW due to an increase in power demand by cloud customers, this would impact the first power directive, and the first power directive would require a −20 KW target power delta distributed solely to consumer objects 1412a, 1412b.

The computing units represented by consumer objects 1412a, 1412b would thus be the first set of the computing units as they are associated with the first device and are available for inclusion in the modeled power consumption distribution. Each of consumer objects 1412a, 1412b is assigned a utility value that is used to distribute the first power directive amongst consumer objects 1412a, 1412b. In one example, the utility value represents a generated monetary value in comparison to power consumption. More specifically, the utility value can be the revenue or profit generated per unit of energy, such as dollar per KWh or joules. If a consumer object represents bitcoin miners, the revenue generated per unit of energy depends on the total hashrate of the bitcoin miners represented by the consumer object per unit of energy and the current price of bitcoin. If consumer objects 1412a, 1412b for example only include bitcoin miners, the utility value analyzed could be simply the total hashrate per unit of energy consumed for the group of bitcoin miners represented by each consumer objects 1412a, 1412b. In such an example, as shown in Table 4, assuming each of consumer objects 1412a, 1412b includes at least tens of miners, and the miners of consumer object 1412a have a total hashrate per unit of energy consumed that is lower than the total hashrate per unit of energy of the miners of consumer object 1412b, the minimum target power of generator 1418a is applied as the first power directive to consumer object 1412a, resulting in a −15 KW power delta for consumer object 1412a.

TABLE 4

| Consumer Object | Utility Value |
|---|---|
| consumer object 1412a | 1.0 TH/KW |
| consumer object 1412b | 3.0 TH/KW |

As discussed above, computing units can be grouped together into consumer objects in different manners than containers and a power directive can consider such different groups when distributing the minimum target power of generator 1418a. For example, each of containers 1414a, 1414b can include two or more consumer objects, and these consumer objects can be considered when applying a power directive. If a first consumer object representing DCUs in container 1414a has a lower utility than the other consumer objects representing DCUs in container 1414a, and all of the consumer objects representing DCUs in container 1414b, then a power directive with a negative power delta is applied to the first consumer object representing DCUs in container 1414a. The consumer objects can be established based on the computing efficiency of the computer units, which can be a result of the computing unit model. Container 1414a can thus be associated with for example a first consumer object representing bitcoin miners each having a first hashrate per unit of energy, a second consumer object representing bitcoin miners each having a second hashrate per unit of energy lower than the first hashrate per unit of energy and a third consumer object representing bitcoin miners each having a third hashrate lower than the second hashrate. In other examples, the consumer objects can include a first consumer object representing bitcoin miners having a first range of hashrates per unit of energy, a second consumer object representing bitcoin miners having a second range of hashrates including a highest hashrate that is lower than a lowest hashrate in the first range, and a third consumer object representing bitcoin miners having a third range of hashrates including a highest hashrate that is lower than a lowest hashrate in the second range.

In another example, the DCUs in containers 1414a, 1414b are GPUs providing cloud computing services to third party client computers and the utility value represents a price paid per time period. More specifically, the utility value can be based on a pricing tier. For example, if the GPUs of consumer object 1412a, 1412b are interruptible via agreement with the customers and the DCUs in container 1414a are providing services to customers paying a lower price than the DCUs in container 1414b, the minimum target power of generator 1418a is applied as the first power directive to consumer object 1412a, resulting in a −15 KW power delta for consumer object 1412a.

If a consumer object having the lowest utility does not have available power to receive a full power delta of a power directive, part of the first power directive is applied to the lowest utility consumer object associated with the device, then the rest is applied to the consumer object with the next lowest utility. For example, referring to Table 4, if consumer object 1412a is only operating at 10 KW, then −10 KW of the −15 KW power delta of the first power directive is applied to consumer object 1412a, and the remaining −5 KW power delta is applied to consumer object 1412b, which is the consumer object with the next lowest utility.

In some embodiments, two or more generators can be synced together to provide a single power output. A target power delta can then be calculated for each generator separately in step 304, and the target power deltas can be considered together for applying a single power directive for the synced generators. If the synced generators have a power delta of the same sign (positive or negative), the power deltas are added together to determine the target power applied in the single power directive. For example, if two generators are synced together, and each has a +5 power delta, the power delta applied by the power directive is +10, and each has a −5 power delta, the power delta applied by the power directive is −10. If the synced generators have a power delta of the opposite sign (positive or negative), the negative power delta is applied in the single power directive. For example, if two generators are synced together, and one has a +5 power delta and the other has a −5 power delta, the power delta applied by the power directive is −5.

The power directives can also include a second power directive distributing the selected target power delta for a second device of power production system 1100 to a second set of the computing units. The second set of the computing unit are those which are associated with the second device and which are available for inclusion in the modeled power consumption distribution.

The second power directive can for example relate to transformers 1416a, 1416b in FIG. 14, which can for example be respective transformers 812, 814 in FIG. 10. A temperature of transformer 1416a can be input into a PID loop to determine a target power delta for the temperature. If no other metrics are analyzed for target power deltas for transformer 1416a, the target power delta for the temperature is used as the selected target power delta for transformer 1416a (step 1304).

For example, because of the primary importance of the generator operating without failure to supplying power to the computing units, a power directive from a transformer cannot be used to increase a power delta distributed by a generator power directive because it could increase the chances of a shutdown. A power directive from a transformer can however be used to decrease a power delta distributed by a generator power directive to avoid overheating of the transformer. In other words, applying the second power directive can include determining that the second power directive is more conservative than the first power directive as cumulatively applied to the computing units of the first set, and then applying the second powered directive to decrease the target power delta distributed to at least one of the computing units of the second set by the first power directive.

Considering for example that consumer objects 1412a, 1412b, 1412d are available for power modification and consumer object 1412c requires an increase of +5 KW due to an increased in cloud computing demand, it is assumed that the transformers 1416a, 1416b and generator 1418a have the power directives as shown in Table 5, and the generator power directive of −15 KW was distributed to consumer object 1412a. Transformer 1416a can be considered the second device and transformer 1416b can be considered the further second device. The computing units represented by consumer objects 1412a, 1412b would thus be the second set of the computing units as they are associated with the second device (transformer 1416a) and are available for inclusion in the modeled power consumption distribution. The computing units represented by consumer objects 1412d would thus be the further second set of the computing units as they are associated with the further second device (transformer 1416b) and are available for inclusion in the modeled power consumption distribution. It is noted that all of the computing units in the second set (consumer objects 1412a, 1412b) and the further second set (consumer objects 1412c, 1412d) are also in the first set (consumer objects 1412a to 1412d), only some of the computing units in the first set are also in the second set, only some of the computing units in the first set are also in the further second set, and the computing units of the second set are distinct from the computing units of the further second set.

TABLE 5

| Device | Power Directive |
|---|---|
| Transformer 1416a | +5 KW |
| Transformer 1416b | −20 KW |
| Generator 1418a | −15 KW |

Applying the second power directives of transformers 1416a, 1416b can include determining that the second power directives are more conservative than the first power directive of generator 1418a as cumulatively applied to the computing units of the first set (i.e., computing units represented by consumer objects 1412a, 1412b, 1412d). As the first power directive of generator 1418a as cumulatively applied to the computing units represented by consumer objects 1412a, 1412b, 1412d has a target power delta of −15 KW, only the second power directive of transformer 1416b has a target power delta (−20 KW) that is more conservative than the first power directive of generator 1418a. Thus, only the second power directive of transformer 1416b is applied to decrease the target power delta distributed to the computing units represented by consumer object 1412d because the consumer object 1412d affected is of lower priority and take all of the target power delta. It should be understood that this power directive application includes verifying that the current state of the consumer objects affected by the directive results in a power decrease of greater than or equal to the power directive.

Because transformer 1416b has a power directive of −20 KW, and available consumer object 1412d associated with transformer 1416b has a 0 KW power delta after the first power directive, the power control module (e.g., power control module 114d or 124d) determines which of consumer objects 1412c, 1412d has the lowest utility by fetching utility data from the respective container orchestrator (e.g., container orchestrator 114c or 124c), and then distributes the −20 KW power delta to the consumer object 1412d. Utility values for consumer objects can be set at the orchestrator level by manual inputs, for example as the mean power efficiency of the DCUs that constitute the consumer object, or can be determined based on data fetched from the DCUs by container orchestrators 114c, 124c, including for example fetching a hashrate and a power consumption from a cryptocurrency miner and multiplying these values times each other. These utility metrics can also be fetched by container orchestrators 114c, 124c from business database 148. As the power directive of transformer 1416a has a positive value, this power directive of transformer 1416a is ignored.

TABLE 6

| | Modeled Power Delta |
|---|---|
| Consumer Object | after 2^{nd} Power Directive |
| consumer object 1412a | −15 KW |
| consumer object 1412b | 0 KW |
| consumer object 1412c | Fixed at +5 KW |
| consumer object 1412d | −20 KW |

The power directives can include a third power directive distributing the determined selected target power delta for a third device of power production system 200 to a third set of the computing units associated with the third device.

The third power directive can for example relate to a device that measures a parameter of natural gas being supplied to the power generation module. The device that measures a parameter of natural gas being supplied to the power generation module can be an inlet pressure sensor 1420 that is in a line feeding gas to all of generators 1418a to 1418c in FIG. 4. The inlet pressure measured by sensor 1420 can be input into a PID loop to determine a target power delta for the inlet pressure. If no other metrics are analyzed for target power deltas for sensor 1420, the target power delta for the inlet pressure is used as the selected target power delta for sensor 1420 (step 1304). In other examples, instead of a sensor 1420, the device that measures a parameter of natural gas being supplied to the power generation module can be inlet pressure or inlet flow sensors of the generators, and measurements can be retrieved from the inlet pressure or inlet flow sensors of the generators to estimate the pressure in fuel gas supply line 1420. In particular, if there are three generators supplied by fuel gas supply line 1420, values from pressure or flow sensors of the generators are retrieved, and an average value is taken for these sensors to estimate the pressure in fuel gas supply line 1420. In other examples, the device that measures a parameter of natural gas being supplied to the power generation module can be a gas flow meter in fuel gas supply line 1420. If the pressure of flow in fuel gas supply line 1420 for example is too low, a negative power delta can allow the pressure in fuel gas supply line 1420 to build up to more optimal levels for operating the generators.

Similar to the second power directive, because of the primary importance of the generator operating without failure to supplying power to the computing units, a power directive from a sensor 1420 cannot be used to increase a power delta distributed by a generator power directive because it could increase the chances of a shutdown. A power directive from sensor 1420 can however be used to decrease a power delta distributed by a generator power directive to avoid the pressure of gas in for example gas supply line 220 from being too low.

As example, it is assumed that all of consumer objects 1412a to 1412e are available for power consumption redistribution in model 1400, and the devices have power directives as shown in the below Table 7.

TABLE 7

| Device | Power Directive |
|---|---|
| Transformer 1416a | +5 KW |
| Transformer 1416b | −20 KW |
| Transformer 1416c | +10 KW |
| Generator 1418a | −15 KW |
| Generator 1418b | +15 KW |
| Pressure sensor 1420 | −45 KW |

The devices discussed above with respect to Table 4 have maintained the same power directives, and thus the distribution to consumer objects 1412a, 1412b, 1412d in Table 5 applies to begin the analysis with respect to the application of the third power directive. Prior to the modeling of the third power directive, consumer object 1412a thus has −15 KW power delta, consumer object 1412b has a 0 KW power delta, and consumer object 1412d has a −20 KW power delta (consumer object 1412c has a fixed +5 KW power delta). As the power directive (+10 KW) of transformer 1416c is more conservative than the power directive (+15 KW) of generator 1418b, the power directive (+10 KW) of transformer 1416c overrides the power directive (+15 KW) of generator 1418b, and consumer object 1412e has a +10 KW power delta achieving the modeled power distribution shown in Table 8.

TABLE 8

| | Modeled Power Delta |
|---|---|
| Consumer Object | after 2^{nd} Power Directive |
| consumer object 1412a | −15 KW |
| consumer object 1412b | 0 KW |
| consumer object 1412c | Fixed at +5 KW |
| consumer object 1412d | −20 KW |
| consumer object 1412e | +10 KW |

The power directive for pressure sensor 1420 is then to be distributed amongst consumer objects 1412a, 1412b, 1412d, 1412e, because sensor 1420 monitors a parameter than impacts power generation for the computing units in each of these consumer objects 1412a to 1412e and consumer object 1412c is unavailable. In the modeled power distribution prior to the application of the power directive of pressure sensor 1420, the cumulative power delta of consumer objects 1412a to 1412e is −20 KW ((−15)+(0)+(5)+(−20)+(10)=−20). A decrease of −25 KW is thus needed to satisfy the power directive of pressure sensor 1420. Because applying −25 KW would not increase the overall power delta applied by any of the generator power directives or the transformer power directives, the leader power control module (e.g., power control module 114d) determines which of consumer objects 1412a, 1412b, 1412d, 1412e has the lowest utility by accessing the utility database, and then distributes the −25 KW power delta to the consumer object 1412a, 1412b, 1412d, 1412e having the lowest utility, which based on the example of Table 9 is consumer object 1412a, achieving the modeled power delta in Table 10 for the consumer objects.

TABLE 9

| Consumer Object | Utility Value |
|---|---|
| consumer object 1412a | 1.0 TH/KW |
| consumer object 1412b | 3.0 TH/KW |
| consumer object 1412c | N/A |
| consumer object 1412d | 6.0 TH/KW |
| consumer object 1412e | 4.0 TH/KW |

TABLE 10

| | Modeled Power Delta |
|---|---|
| Consumer Object | after 3^{rd} Power Directive |
| consumer object 1412a | −40 KW |
| consumer object 1412b | 0 KW |
| consumer object 1412c | Fixed at +5 KW |
| consumer object 1412d | −20 KW |
| consumer object 1412e | +10 KW |

It is noted that the terms first device, second device and third device do not identify any specific device and the terms first power directive, second power directive and third power directive do not identify any specific device power directive. For example, the power directive for the pressure sensor 1420 can be considered the second power directive. Accordingly, it can be said that the second device measures a parameter of natural gas being supplied to the power generation module, and all of the computing units in the first set (e.g., consumer objects 1412a to 1412d) are also in the second set (e.g., consumer objects 1412a to 1412e) and only some of the computing units in the second set are also in the first set of determining a target power production framework that includes a target power delta for each of a plurality of devices associated with the power production system. The target power deltas are based on the metrics of power production system.

A next substep 1306c in the optimal power consumption distribution model determination is applying the at least one device constraint to the modeled power distribution resulting from substep 1306b. Substep 1306c can include limiting the target power production framework resulting from step 1304 by applying at least one constraint of at least one of the devices to determine the optimal power consumption distribution model.

Specifically, the limiting of the target power production framework from step 1304 includes applying to the at least one constraint of at least one of the devices to the modeled power distribution resulting from the application of the power directives in substep 1306b, such that each constraint alters at least one of the target power deltas applied to the computing units associated with the respective device when the target power deltas applied to the computing units associated with the respective device in the modeled power distribution cumulatively cause a violation of said constraint.

For example, the limiting of the target power production framework from step 1304 can include applying to the at least one constraint of generator 1418a to the modeled power distribution resulting from the application of the power directives in substep 1306b, such that each constraint alters at least one of the target power deltas applied to consumer objects 1412a to 1412d associated with the generator 1418a when the target power deltas applied to generators 1418a in the modeled power distribution resulting from substep 1306b cumulatively cause a violation of said constraint.

Device constraints can include a predefined maximum power of a generator, a predefined minimum power of a generator, a predetermined maximum ramp up rate of the generator and/or a predetermined minimum ramp down rate of a generator, and substep 1306c can involve analyzing the modeled power distribution resulting from substep 1306b in view of each of these device constraints.

The device constraints can be analyzed in terms of absolute power or a power delta. In particular, a predefined maximum power of a generator and a predefined minimum power of a generator are analyzed in terms of absolute power, while a predefined maximum ramp up and/or predefined minimum ramp down rate of a generator are analyzed in terms of a power delta.

With respect to a predefined maximum power of a generator, this maximum power is compared to the determined absolute target power for the generator resulting from the substep 1306b. This absolute target power is the target power delta for the generator at the end of substep 1306b plus the current power of the generator. In other words, the absolute target power is the current power of the generator plus the generator target power delta from the first power directive (i.e., generator target power delta from substep 1306a), and any decrease of the generator target power delta resulting from the subsequent power directives (e.g., the second and third power directives) plus the current power of the generator.

Referring to the example shown in Table 10, if the current power of the generator 1418b is 450 KW, and the predefined maximum power of generator 1418b is 455 KW, a target power delta of +10 KW for the consumer object 1418e powered by generator 1418b resulting from substep 1306b would result in an absolute target power of 460 KW violating this predefined maximum power. The target power delta of +10 KW is thus altered by the predefined maximum power of generator 1418b and decreased by 5 KW to +5 KW. The target power delta for consumer object 1412e is then decreased to +5 KW by the predefined maximum power of generator 1418b.

With respect to a predefined minimum power of a generator, this minimum power is also compared to the determined absolute target power for the generator resulting from the substep 1306b. This absolute target power is the target power delta for the generator at the end of substep 1306b plus the current power of the generator. In other words, the absolute target power is the current power of the generator plus the generator target power delta from the first power directive (i.e., generator target power delta from substep 1306a), and any decrease of the generator target power delta resulting from the subsequent power directives (e.g., the second and third power directives) plus the current power of the generator.

Referring to the example shown in Table 10, if the current power of the generator 1418a is 200 KW, and the predefined minimum power of generator 1418a is 190 KW, the target power delta of cumulative-40 KW power delta resulting from substep 1306b for consumer objects 1412a to 1412d powered by generator 1418a would result in an absolute target power of 160 KW violating this predefined minimum power. The target power delta of −40 KW is thus altered by the predefined minimum power of generator 1418a and increased by 30 KW to −10 KW. Using the utility values shown in Table 9 for the consumer objects 1412a to 1412d associated with generator 1418a, this increase of 30 KW is thus allocated to consumer object 1412d having the highest utility value, increasing the target power delta of consumer object 1412d to +30 KW.

With respect to a predefined maximum ramp up rate of a generator, this maximum ramp up rate is compared to the determined target power delta for the generator resulting from the substep 1306b. The determined target power delta for the generator resulting from the substep 1306b is the generator target power delta from the first power directive (i.e., generator target power delta from substep 1306a), and any decrease of the generator target power delta resulting from the subsequent power directives (e.g., the second and third power directives).

Referring to the example shown in Table 11, the target power delta resulting from substep 1306b is +10 KW during a predefined time period for generator 1418b, and if the predefined maximum ramp up rate of generator 1418b is +55 KW during the same predefined time period, the target power delta of +10 KW resulting from substep 1306b is not altered by the predefined maximum ramp up rate of generator 1418b because it does not violate the predefined maximum ramp up rate. However, if the target power delta resulting from substep 1306b is +75 KW during a predefined time period for generator 1418b, it would violate +55 KW maximum ramp up rate, and the target power delta for generator 1418b, and the corresponding target power delta of consumer object 1412e, is reduced by −20 KW. If generator 1418b provided power to multiple consumer objects, the consumer object with the lowest utility is reduced by −20 KW if the consumer object with the lowest utility has a current power of at least 20 KW. As noted above, if the consumer object with the lowest utility has a current power of less than 20 KW, a portion of the −20 KW power delta is distributed to the consumer object with the lowest utility and a portion of the −20 KW power delta is distributed to the consumer object with the second lowest utility.

With respect to a predefined minimum ramp down rate of a generator, this minimum ramp down rate is compared to the determined target power delta for the generator resulting from the substep 1306b. The determined target power delta for the generator resulting from the substep 1306b is the generator target power delta from the first power directive (i.e., generator target power delta from substep 1306a), and any decrease of the generator target power delta resulting from the subsequent power directives (e.g., the second and third power directives).

Referring to the example shown in Table 10, the cumulative target power delta resulting from substep 1306b is −40 KW during the predefined time period for consumer objects 1412a to 1412d associated with generator 1418a, and if the predefined minimum ramp down rate of generator 1418a is −60 KW during the same predefined time period, the target power delta of −40 KW resulting from substep 1306b is not altered by the predefined minimum ramp down rate of generator 1418a because it does not violate the minimum ramp down rate. However, if the target power delta resulting from substep 1306b is −75 KW during a predefined time period for generator 1418a, it would violate −60 KW minimum ramp down rate. Because the power delta required by the predefined minimum ramp down rate of generator 1418a is a positive power delta, it is allocated to the highest utility consumer object, which in Table 10 is consumer object 1412d. As consumer object 1412d had a target power delta of 0 KW at the end of substep 1306b, it would be increased from 0 KW to +15 KW.

If the predefined minimum power of generator 1418a is taken into account as noted above, and the power of consumer object 1412d was already increased from 0 KW to +30 KW, the cumulative target power delta for consumer objects 1412a to 1412d associated with generator 1418a is above the predefined minimum ramp down rate of generator 1418a, and there is no further increase of the cumulative target power delta for consumer objects 1412a to 1412d associated with generator 1418a based on the predefined minimum ramp down rate of generator 1418a.

In a next substep 1306d, the target power deltas resulting from substep 1306c for each of the consumer objects is sent for distribution within the consumer objects. More specifically, the target power deltas resulting from substep 1306c for each of the consumer objects is sent from a respective power control module (e.g., the lead power control module 114d or 124d) to the respective container orchestrator (e.g., container orchestrator 114c, 124c). Referring to the example in FIG. 14, this can include sending the power delta for consumer objects 1412a, 1412b to the container orchestrator of container 1414a, sending the power delta for consumer object 1412c to the container orchestrator of container 1414b, sending the power delta for consumer object 1412d to the container orchestrator of container 1414c and sending the power delta for consumer object 1412e to the container orchestrator of container 1414d.

As the power changes for the DCUs of consumer objects 1412a, 1412b, 1412d are impacted by the +5 KW increase of the DCUs of consumer object 1412c, the power control modules can output a control signal in substep 1306d that varies a power consumption of the DCUs of consumer objects 1412a, 1412b, 1412d based on a difference between the real-time power consumption metrics for the DCUs of consumer object 1412c and the rated power consumption of the DCUs of consumer object 1412c.

In a next substep 1306e, target power deltas in the modeled power distribution are distributed to the computing units of each group, i.e., each consumer object, by allocating the power deltas to the computing units of each of a plurality of groups of computing units based on a hierarchy of each of the computing units within the respective group.

For example, this distribution within the groups can include distributing the target power delta for consumer object 1412a to the computing units represented by consumer object 1412a based on the hierarchy of each of the computing units represented by consumer object 1412a and distributing the target power delta for consumer object 1412b to the computing units represented by consumer object 1412b based on the hierarchy of each of the computing units represented by consumer object 1412b. More specifically, this distribution within the groups includes retrieving the hierarchy ordering the computing units of a first group based on a specified utility of each of the computing units within the first group, and allocating a power delta distributed by the modeled power distribution to the computing units of the first group based on the hierarchy. Referring to consumer object 1412a, this can include retrieving the hierarchy ordering the computing units of consumer object 1412a based on a specified utility of each of the computing units of consumer object 1412a, and allocating a power delta distributed by the modeled power distribution resulting from substep 1306c to the computing units of consumer object 1412a based on the hierarchy.

As discussed further above, a single power control module can be elected by a system orchestrator (e.g., system orchestrator 130c in FIG. 1) for all of the container orchestrators on the same local area network, and the single power control module can send the target power deltas resulting from substep 1306c to the respective container orchestrator (e.g., a respective container orchestrator in each of containers 1414a to 1414d). The container orchestrator can take the target power deltas for each of consumer objects 1412a to 1412e resulting from substep 1306c and translate these target power deltas into workmode changes for the computing units represented by each consumer object 1412a to 1412e. The workmode changes can including turning on or turning off the computing units, or sending a command to enter a specific predefined power mode including for example lower power mode (e.g., less than 3 KW), normal power mode (e.g., 3 to 5 KW) or higher power mode (e.g., greater than 5 KW).

The translation of these target power deltas into workmode changes for the computing units represented by each consumer object 1412a to 1412e can include identifying, based on priority or hierarchy information associated with each of the DCUs, which DCUs should be subject to the target power delta for the consumer object. The priority or hierarchy information can be a utility value, which as noted above can represent a monetary value generated by the DCU in comparison to power consumption. If the power delta is a power decrease, one or more DCUs having the highest utility value can be selected for powering down, and thus the altering of the power state is changing the power from on to off. If the power delta is a power increase, one or more DCUs having the highest utility value can be selected for powering up, and thus the altering of the power state is changing the power from off to on. DCUs can also be provided with firmware that allows the amount of power drawn by each DCU 112, 122 to be increased or decreased within a range of non-zero to 100%.

As discussed above, each container orchestrator (e.g., FIG. 1 at 114c, 124c) can retrieve a hierarchy of the DCUs 112, 122 that it controls (e.g., container orchestrator 114c controls DCUs 112, and container orchestrator 124c controls DCUs 122). Each container orchestrator may further populate a data record comprising the respective hierarchy and the power currently being consumed by each DCU 112, 122. If, for example, the output power of the power generation module(s) powering the DCUs 112, 122 needs to be decreased, the container orchestrators 114c, 124c can select the lowest utility (or lowest priority) DCUs 112, 122 for powering down to achieve the required power reduction. In particular, the container orchestrator 114c, 124c can, for example, start from the bottom of the hierarchy and select the lowest utility DCU for deactivation, then select the second lowest utility priority DCU, and this process continues until the selected DCUs together have achieved the power delta resulting from substep 1306c for the respective consumer object. Conversely, if more than one of the DCUs of the consumer object are currently turned off and not drawing power, then the hierarchy can be used to for selecting DCUs for activation to achieve the power delta resulting from substep 1306c. It will be appreciated that higher utility DCUs 112, 122 in the hierarchy will be selected for activation before lower utility DCUs 112, 122.

For example, if the DCUs 112 are different models of cryptocurrency miners, the DCUs 112 can be prioritized by profitability (e.g., total hashrate per unit of energy consumed), which can include selecting DCUs 112 for powering based on the age of the DCU 112. If the five least profitable DCUs 112 collectively have an output of at least the power delta resulting from substep 1306c, such DCUs 112 are selected for shutdown, and the remaining DCUs 112 continue to mine cryptocurrency and draw power from the respective power generation module(s).

Step 1306 can include taking into consideration ambient temperatures at the site, a temperature of a coolant used to cool the DCUs, and/or internal chip temperatures of the DCUs to allocate the target power deltas to consumer objects (e.g., in substep 1306b) or to DCUs within each consumer object (e.g., in substep 1306c). In some examples, DCUs can include firmware allowing the DCUs in the form of cryptocurrency miners to be operated in lower power mode (lower computing speed), a normal mode (normal computing speed) and a higher power mode (higher computing speed). Miners can operate in lower power modes at much higher ambient air temperatures than miners can operate in normal power modes and higher power modes. These lower power modes can allow system 103 to capture utility in high-temperature environments (Permian, MENA, Bakken hot weather) where miners would otherwise not operate. For substep 1306b, upon a measurement that the ambient temperatures at the site and/or internal temperatures of the miners are above a predetermined threshold, the modeled power distribution can account for all of the DCUs being be forced into lower power mode, then one or more consumer objects can be allocated a negative power delta if a further negative power delta is required by the power directives or by at least one device constraint (substep 1306c). For substep 1306e, instead of allocating a target power delta in the modeled power distribution by powering down individual miners of a consumer object, the target power delta can be allocated by operating a plurality of the miners in a lower power mode based on a measurement of the ambient temperatures at the site and/or internal temperatures of the miners being above a predetermined threshold.

For example, if the DCUs in a container are cooled by water, a first temperature parameter to check lower deciding if a lower power mode should be implemented is inlet water temperature. The predetermined threshold for this parameter is approximately (+/−20%) 50° C. A second temperature parameter to check is the maximum chip temp for each DCU. The predetermined threshold for this parameter is approximately (+/−20%) 105° C. If the ambient was getting too hot it is expected that maximum chip temperatures can reach the predetermined threshold for the second temperature parameter one DCU at a time. But if the first temperature parameter is the limiting value, many miners could reach the predetermined threshold almost simultaneously. Accordingly, DCUs are forced into lower power mode when either the predetermined threshold is reach for the first temperature parameter or the second temperature parameter.

Then when the ambient temperature cools down, the water, and the chips cool down also. The same two parameters are checked, against different criteria, to know when it is safe to go back to the higher power mode. Different thresholds are used to avoid unnecessary switching back and forth between modes. The first temperature parameter threshold for switching back to high temperature mode can be for example approximately (+/−20%) 45° C., and the second temperature parameter threshold for switching back to high temperature mode can be for example approximately (+/−20%) 100° C. DCUs are automatically shift from lower power mode back to high power mode only when the predetermined threshold is reached for both the first temperature parameter and the second temperature parameter. The first and second temperature parameter thresholds can also be set based on a weather forecast and temperature specifications of the DCUs.

Additionally, lower power mode also improves power-use efficiency, providing an improvement in utility during low-gas scenarios. A low gas scenario can be an engine pressure below a predetermined internal, such as 40 psi for an engine-type generator or below 320 psi for a turbine-type generator. A low gas scenario can also be a pressure at sensor 674 below a predetermined internal, such as 50 psi for an engine-type generator. For substep 1306b, upon a measurement that a measurement, by a pressure sensor (e.g., by a pressure sensor 674) or flow meter, of a parameter of natural gas being supplied to the power generation module being is a predetermined threshold, the modeled power distribution can account for all of the DCUs being be forced into lower power mode, then one or more consumer objects can be allocated a negative power delta if a further negative power delta is required by the power directives or by at least one device constraint (substep 1306c). For substep 1306e, instead of allocating a target power delta by powering down individual miners of a consumer object, the target power delta can be allocated by operating a plurality of the miners in a lower power mode based on a measurement of a parameter of natural gas being supplied to the power generation module below a predetermined threshold.

Upon completing step 1306, step 1308 of method 1300 is performed. This step comprises altering the power state of the DCUs 112 and/or 122 determined in step 1306 to achieve the optimal power consumption distribution model. Finally, the method 1300 may conclude with step 1310, which comprises periodically repeating steps 1302 to 1308.

### Data Centers

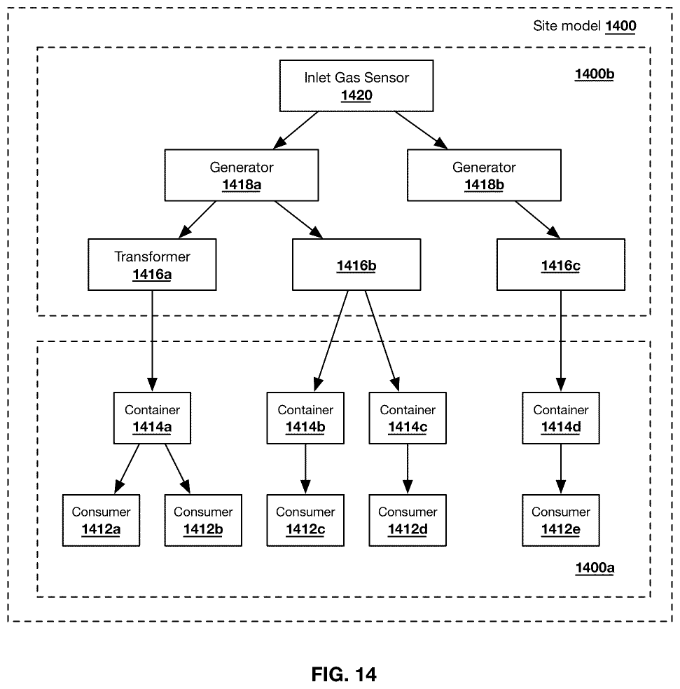

Referring to FIG. 15, an exemplary data center 1510 according to an embodiment is illustrated that can be used for data center 110. As shown, the data center 1510 may comprise various electrical components, such as but not limited to: any number of computing units 1520, a communications system 1555, an electrical power system 1530, a backup power system 1540, and/or a monitoring and control system 1580.

Generally, each of the data centers 1510 may comprise a prefabricated housing or enclosure to contain and protect the various electronics. The enclosure may be designed for durability, safety, stack-ability, ventilation, weatherproofing, dust control and operation in various conditions.

As shown, each of the data centers 1510 may comprise an electrical power system 1530 adapted to receive electrical power 1501 from a primary source (e.g., renewable energy source or the grid, FIG. 1 at 206A, 206B) or a secondary source (e.g., electrical power generation system, FIG. 1 at 108), as discussed above. More particularly, the power system 1530 may receive an output electrical flow from a primary energy source 1501 or secondary energy source 1505 via cable trays, buried lines and/or overhead suspended lines. In certain embodiments, each data center 1510 may be fitted with quick connects (discussed above), which are pre-terminated into the power system 1530.

In one embodiment, the electrical power system 1530 of a data center may comprise one or more breaker panels in electrical communication with a series of PDUs or power channels. Such PDUs may also be in communication with the various electrical components of the data center 1510, such as computing units 1520, backup power systems 1540 (e.g., batteries and/or diesel generators), a communication system 1555, and/or a monitoring and control system 1580.

In certain embodiments, the breaker panels and/or PDUs of the power system 1530 may be in communication with a monitoring and control system 1580 of the data center 1510, which can include container controllers 114, 124. And such monitoring and control system 1580 may be in communication with the remote monitoring and control system (e.g., central control system 101) via a network such that an operator may remotely control (activate and/or deactivate) these components and all electrical equipment in electrical communication therewith. For example, PDUs may be remotely “power cycled” to reset, reboot or restart malfunctioning equipment without the expense or time required to deploy a human. As another example, breaker panel switches may be remotely controlled to turn on/off power to downstream systems without the need for human dispatch.

As shown, each of the data centers 1510 may comprise a plurality of computing units 1520, wherein the computing units are powered via the power system 1530 and, optionally, via the backup power system 1540. As discussed above, the computing units are adapted to conduct any number of processing operations.

As discussed above, the data centers 1510 and the various electronic components contained therein (e.g., computing units 1520, monitoring and control system 1580, power system 1530 and/or backup power system 1540) may be connected to a network via wired or wireless connection to a communication system 1555. The communication system 1555 may comprise one or more modems, network switches, and network management computers to provide connectivity to the network, such as the Internet, via a fiber optic cable, fixed point wireless (laser, millimeter wave towers, microwave towers or the like used to relay high speed internet on a line-of-sight basis), satellite internet, cell-based internet or any other means of internet connection. And the components of the communication system 1555 may be distributed throughout the data center 1510 as required to connect all computing units 1520 into the network and to supply sufficient data input and output bandwidth for all connected components.

It will be appreciated that heat and airflow management are important considerations. Moreover, excessive dust and precipitation must also be monitored and controlled during operation. Accordingly, in one embodiment, the monitoring and control system 1580 may be adapted to control various parameters of the data centers 1510, such as temperature, moisture, oxygen, power and/or others.

It will be appreciated that the data center 1510 may be further designed with various safety and security features. For example, the data centers 1510 may comprise one or more wireless cameras controlled by the monitoring and control system 1580 and powered by the power system 1530 and/or the backup power system 1540. Such cameras may be specified for continuous remote monitoring and/or motion-activated recording. As another example, the data centers 1510 may comprise may comprise motion activated lighting systems that serve as an additional crime deterrent and/or that may provide sufficient light to facilitate work during nighttime operations.

### Cryptocurrency Mining System

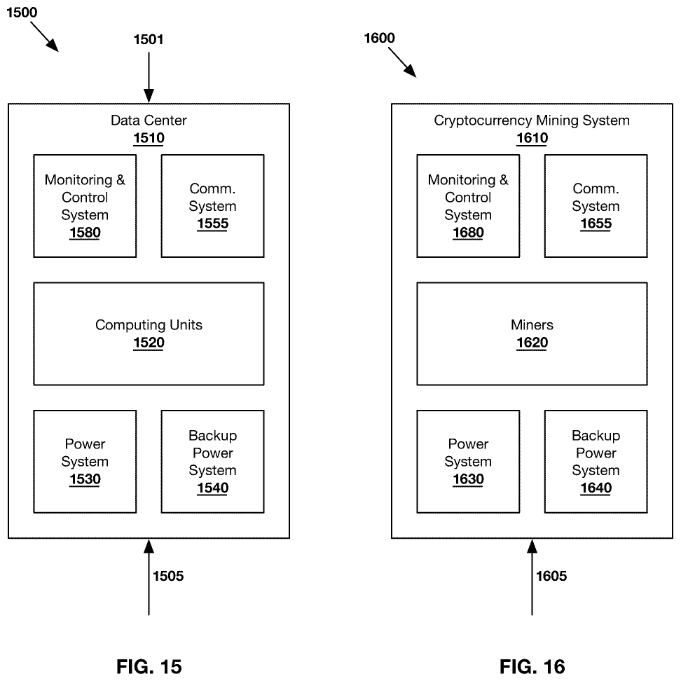

Referring to FIG. 16, an exemplary cryptocurrency mining system 1600 that can form interruptible computing load container 120 according to an embodiment is illustrated. As shown, the system 1600 may include one or more data centers or containers 1610 comprising various electrical components, such as but not limited to: any number of cryptocurrency miners 1620, a communications system 1655, an electrical power system 1630, a backup power system 1640, and/or a monitoring and control system 1680.

Generally, each of the containers 1610 may comprise a prefabricated housing or enclosure to contain and protect the various electronics. The enclosure may comprise a customized shipping container or other modular housing system designed for portability, durability, safety, stack-ability, ventilation, weatherproofing, dust control and operation in rugged conditions.

As shown, each of the containers 1610 may comprise an electrical power system 1630 adapted to receive electrical power 1605 from an electrical power generation system, as discussed above. More particularly, the power system 1630 may receive an output electrical flow 1605 from the electrical power generation system via cable trays, buried lines and/or overhead suspended lines. In certain embodiments, each container 1610 may be fitted with quick connects (discussed above), which are pre-terminated into the power system 1630.

In one embodiment, the electrical power system 1630 of a container may comprise one or more breaker panels in electrical communication with a series of power distribution units (“PDUs”) or power channels. Such PDUs may also be in communication with the various electrical components of the container 1610, such as miners 1620, backup power systems 1640 (e.g., batteries and/or solar panels), a communication system 1655, and/or a monitoring and control system 1680.

In certain embodiments, the breaker panels and/or PDUs of the power system 1630 may be in communication with a monitoring and control system 1680 of the container 1610. And such monitoring and control system 1680 may be in communication with the remote monitoring and control system via a network such that an operator may remotely control (activate and/or deactivate) these components and all electrical equipment in electrical communication therewith. For example, PDUs may be remotely “power cycled” to reset, reboot or restart malfunctioning equipment without the expense or time required to deploy a human. As another example, breaker panel switches may be remotely controlled to turn on/off power to downstream systems without the need for human dispatch.

As shown, each of the containers 1610 may comprise a plurality of cryptocurrency miners 1620, wherein the miners are powered via the power system 1630 and, optionally, via the backup power system 1640. As discussed above, the miners are adapted to conduct any number of cryptocurrency mining operations.

It will be appreciated that the number of containers, the number of miners contained in each container, and/or the processing power of such miners may be selected to utilize substantially all electrical power generated by the electrical power generation system. For example, the components of the cryptocurrency mining system may be selected, configured, added and/or removed, as necessary to allow the system 1600 to consume the maximum practical amount of the power generated by the electrical power generation system (typically in excess of 90% of the available power). This allows for revenue generated from mining tasks tasks to be maximized.

As discussed above, the containers 1610 and the various electronic components contained there (e.g., miners 1620, monitoring and control system 1680, power system 1630 and/or backup power system 1640) may be connected to a network via wired or wireless connection to a communication system 1655. The communication system 1655 may comprise one or more modems, network switches, and network management computers to provide connectivity to the network, such as the Internet, via a fiber optic cable, fixed point wireless (laser, millimeter wave towers, microwave towers or the like used to relay high speed internet on a line-of-sight basis), satellite internet, cell-based internet or any other means of internet connection. And the components of the communication system 1655 may be distributed throughout the container 1610 as required to connect all miners 1620 into the network and to supply sufficient data input and output bandwidth for all connected components.

It will be appreciated that heat and airflow management are important considerations. Moreover, excessive dust and precipitation must also be monitored and controlled during operation. Accordingly, in one embodiment, the monitoring and control system 1680 may be adapted to control various parameters of the container 1610, such as temperature, moisture, oxygen, power and/or others.

In one embodiment, the container 1610 may be designed with a cold aisle and a hot aisle. For example, the miners 1620 may be located within vertically stacked, horizontal racks extending along a row within the container; and all of the miners may be positioned within the racks such that their intake fans point towards the cold aisle, while their exhaust fans point in an opposite direction, towards the hot aisle. It will be appreciated that one or more air inlets of the container 1610 may be aligned with the cold aisle and one or more exhausts of the container be aligned with the hot aisle.

The container 1610 may comprise various louvers, dampers, filters and/or awnings designed to protect against direct and wind-blown precipitation, as well as excessive dust intake. In such cases, dampers may be connected to the monitoring and control system 1680 such that they may be automatically closed to seal and the container in the event of a power failure.

It will be appreciated that the container 1610 may be further designed with various safety and security features. For example, the container 1610 may comprise one or more wireless cameras controlled by the monitoring and control system 1680 and powered by the power system 1630 and/or the backup power system 1640. Such cameras may be specified for continuous remote monitoring and/or motion-activated recording. As another example, the container 1610 may comprise may comprise motion activated lighting systems that serve as an additional crime deterrent and/or that may provide sufficient light to facilitate work during nighttime operations.

And as yet another example, the container 1610 may comprise a fire suppression system designed to retard gas and electrical fires. In one embodiment, the monitoring and control system 1680 may cause the dampers to automatically seal when extreme temperatures are detected (i.e., to cut off oxygen flow to a fire inside the container).

### Computing Machines

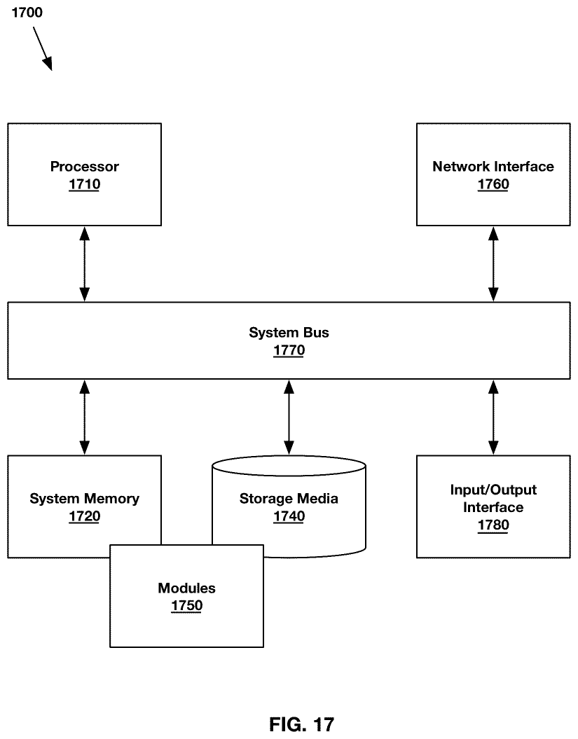

Referring to FIG. 17, a block diagram is provided illustrating an exemplary computing machine 1700 and modules 1750 in accordance with one or more embodiments presented herein. The computing machine 1700 may represent any of the various computing systems discussed herein, such as but not limited to, the first computing units (FIG. 1 at 1120), the cryptocurrency miners (FIG. 1 at 122), and the monitoring and control system (FIG. 1 at 114), And the modules 1750 may comprise one or more hardware or software elements configured to facilitate the computing machine 1700 in performing the various methods and processing functions presented herein.

The computing machine 1700 may comprise all kinds of apparatuses, devices, and machines for processing data, including but not limited to, a programmable processor, a computer, and/or multiple processors or computers. As shown, an exemplary computing machine 1700 may include various internal and/or attached components, such as a processor 1710, system bus 17170, system memory 1720, storage media 1740, input/output interface 1780, and network interface 1760 for communicating with a network 1730.

The computing machine 1700 may be implemented as a conventional computer system, an embedded controller, a server, a laptop, a mobile device, a smartphone, a wearable device, a set-top box, over-the-top content TV (“OTT TV”), Internet Protocol television (“IPTV”), a kiosk, a vehicular information system, one more processors associated with a television, a customized machine, any other hardware platform and/or combinations thereof. Moreover, a computing machine may be embedded in another device, such as but not limited to, a smartphone, a personal digital assistant (“PDA”), a tablet, a mobile audio or video player, a game console, a Global Positioning System (“GPS”) receiver, or a portable storage device (e.g., a universal serial bus (“USB”) flash drive). In some embodiments, such as the DCUs, the computing machine 1700 may be a distributed system configured to function using multiple computing machines interconnected via a data network or system bus 1770.

The processor 1710 may be configured to execute code or instructions to perform the operations and functionality described herein, manage request flow and address mappings, and to perform calculations and generate commands. The processor 1710 may be configured to monitor and control the operation of the components in the computing machine 1700. The processor 1710 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 1710 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor 1710 and/or other components of the computing machine 1700 may be a virtualized computing machine executing within one or more other computing machines.

The system memory 1720 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 1720 also may include volatile memories, such as random-access memory (“RAM”), static random-access memory (“SRAM”), dynamic random-access memory (“DRAM”), and synchronous dynamic random-access memory (“SDRAM”). Other types of RAM also may be used to implement the system memory. The system memory 1720 may be implemented using a single memory module or multiple memory modules. While the system memory is depicted as being part of the computing machine 1700, one skilled in the art will recognize that the system memory may be separate from the computing machine without departing from the scope of the subject technology. It should also be appreciated that the system memory may include, or operate in conjunction with, a non-volatile storage device such as the storage media 1740.

The storage media 1740 may include a hard disk, a flash memory, other non-volatile memory device, a solid-state drive (“SSD”), any magnetic storage device, any optical storage device, any electrical storage device, any semiconductor storage device, any physical-based storage device, any other data storage device, or any combination or multiplicity thereof. The storage media 1740 may store one or more operating systems, application programs and program modules such as module, data, or any other information. The storage media may be part of, or connected to, the computing machine 1700. The storage media may also be part of one or more other computing machines that are in communication with the computing machine such as servers, database servers, cloud storage, network attached storage, and so forth.

The modules 1750 may comprise one or more hardware or software elements configured to facilitate the computing machine 1700 with performing the various methods and processing functions presented herein. The modules 1750 may include one or more sequences of instructions stored as software or firmware in association with the system memory 1720, the storage media 1740, or both. The storage media 1740 may therefore represent examples of machine or computer readable media on which instructions or code may be stored for execution by the processor. Machine or computer readable media may generally refer to any medium or media used to provide instructions to the processor. Such machine or computer readable media associated with the modules may comprise a computer software product. It should be appreciated that a computer software product comprising the modules may also be associated with one or more processes or methods for delivering the module to the computing machine 1700 via the network, any signal-bearing medium, or any other communication or delivery technology. The modules 1750 may also comprise hardware circuits or information for configuring hardware circuits such as microcode or configuration information for an FPGA or other PLD.

The input/output (“I/O”) interface 1780 may be configured to couple to one or more external devices, to receive data from the one or more external devices, and to send data to the one or more external devices. Such external devices along with the various internal devices may also be known as peripheral devices. The I/O interface 1780 may include both electrical and physical connections for operably coupling the various peripheral devices to the computing machine 1700 or the processor 1710. The I/O interface 1780 may be configured to communicate data, addresses, and control signals between the peripheral devices, the computing machine, or the processor. The I/O interface 1780 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, Fire Wire, various video buses, and the like. The I/O interface may be configured to implement only one interface or bus technology. Alternatively, the I/O interface may be configured to implement multiple interfaces or bus technologies. The I/O interface may be configured as part of, all of, or to operate in conjunction with, the system bus 1770. The I/O interface 1780 may include one or more buffers for buffering transmissions between one or more external devices, internal devices, the computing machine 1700, or the processor 1710.

The I/O interface 1780 may couple the computing machine 1700 to various input devices including mice, touch-screens, scanners, biometric readers, electronic digitizers, sensors, receivers, touchpads, trackballs, cameras, microphones, keyboards, any other pointing devices, or any combinations thereof. When coupled to the computing device, such input devices may receive input from a user in any form, including acoustic, speech, visual, or tactile input.

The I/O interface 1780 may couple the computing machine 1700 to various output devices such that feedback may be provided to a user via any form of sensory feedback (e.g., visual feedback, auditory feedback, or tactile feedback). For example, a computing machine can interact with a user by sending documents to and receiving documents from a device that is used by the user (e.g., by sending web pages to a web browser on a user's client device in response to requests received from the web browser). Exemplary output devices may include, but are not limited to, displays, speakers, printers, projectors, tactile feedback devices, automation control, robotic components, actuators, motors, fans, solenoids, valves, pumps, transmitters, signal emitters, lights, and so forth. And exemplary displays include, but are not limited to, one or more of: projectors, cathode ray tube (“CRT”) monitors, liquid crystal displays (“LCD”), light-emitting diode (“LED”) monitors and/or organic light-emitting diode (“OLED”) monitors.

Embodiments of the subject matter described in this specification can be implemented in a computing machine 1700 that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Accordingly, the computing machine 1700 may operate in a networked environment using logical connections through the network interface 1760 to one or more other systems or computing machines across a network.

The processor 1710 may be connected to the other elements of the computing machine 1700 or the various peripherals discussed herein through the system bus 1770. It should be appreciated that the system bus 1770 may be within the processor, outside the processor, or both. According to some embodiments, any of the processor 1710, the other elements of the computing machine 1700, or the various peripherals discussed herein may be integrated into a single device such as a system on chip (“SOC”), system on package (“SOP”), or ASIC device.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

It will be understood by those skilled in the art that the drawings are diagrammatic and that further items of equipment such as temperature sensors, pressure sensors, pressure relief valves, control valves, flow controllers, level controllers, holding tanks, storage tanks, and the like may be required in a commercial plant.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A power management system for powering a primary group of power consumers and an secondary group of power consumers, the primary group of power consumers including a data center including a plurality of first computing units, the secondary group of power consumers including a plurality of second computing units whose power consumption is adjustable to ensure the first computing units are continuously powered, the first computing units in communication with a network for providing cloud services to remote client computers, the first computing units having an energy priority over the second computing units, the power management system comprising:
power sources including a first power source and a second power source, the second power source being a power generation module configured to consume natural gas and continuously generate an electrical output sufficient to alternatively power the plurality of first computing units and the second computing units; and
a monitoring and control system configured to:
receive status inputs including:
an operational status and/or an operational cost of each of the power sources; and
power consumption metrics of the primary group of power consumers and/or the secondary group of power consumers; and
output a control signal to decrease a power consumption by the secondary group of power consumers and to power the primary group of power consumers by the second power source as a function of the operational status and/or operational cost of each of the power sources.

2. The power management system as recited in claim 1 wherein the first power source is an electricity grid for powering the primary group of power consumers, the power management system further comprising:
a power switching system configured to alternatively supply electricity from the first power source or the second power source to the computing units,
the monitoring and control system configured to:
receive status inputs including:
an operational status of the electricity grid indicating an availability of electricity from the electricity grid to power the data center; and
an operational cost of the electricity grid indicating a price of electricity from the electricity grid; and
output a control signal to the power switching system to switch from the first power source to the second power source to supply electricity to the computing units based on the status inputs, at least some of the electricity generated by the second power source being redirected from the secondary group of power consumers to the first group of power consumers in response to the control signal.

3. The power management system as recited in claim 1 wherein the first power source is an electricity grid for powering the primary group of power consumers, the power management system further comprising:
a third power source, the third power source being a renewable energy source,
a power switching system configured to alternatively supply electricity from the first power source, the second power source or the third power source to the computing units,
the monitoring and control system configured to:
receive status inputs including:
an operational status of each of the first power source and the third power source indicating an availability of electricity from each of the first power source and the third power source to power the data center; and
an operational cost of each of the first power source and the third power source indicating a price of electricity from each of first power source and the third power source; and
output a control signal to the power switching system to switch from the first power source and/or the third power source to the second power source to supply electricity to the computing units based on the status inputs, at least some of the electricity generated by the second power source being redirected from the secondary group of power consumers to the first group of power consumers in response to the control signal.

4. The power management system as recited in claim 1 further comprising a carbon capture system configured to receive exhaust gas from the second power source, capture carbon from the exhaust gas and release oxygen from the exhaust gas into the atmosphere.

5. The power management system as recited in claim 4 wherein the carbon capture system captures at least about 75% of the carbon from the exhaust gas.

6. The power management system as recited in claim 1 wherein the secondary group of power consumers are cryptocurrency miners and the status inputs include a revenue generated by the cryptocurrency miners per unit of electrical energy.

7. The power management system as recited in claim 6 wherein the status inputs include a price of natural gas per unit and power generated per unit of natural gas by the electrical power generation system.

8. The power management system as recited in claim 6, wherein the revenue generated by the cryptocurrency miners per unit of electrical energy is a function of a current market price of the cryptocurrency, a mining difficulty associated with the cryptocurrency, an average hash rate of the cryptocurrency miners, and/or a power consumption of the cryptocurrency miners.

9. The power management system as recited in claim 3 wherein the secondary group of power consumers are cryptocurrency miners and the monitoring and control system is configured to output a control signal to the power switching system to switch from the first power source and/or the third power source to the second power source to supply electricity to the computing units when a price of electricity from a least expensive of the first power source and the third power source is greater than a threshold power price derived from a value of the cryptocurrency with respect to a government currency, a hashrate of the cryptocurrency miners and a cost to operate the cryptocurrency miners.

10. The power management system as recited in claim 9 wherein the cost to operate the cryptocurrency miners includes a cost of thermal management for the cryptocurrency miners.

11. The power management system as recited in claim 1 wherein the second power source has a power output at least as great as a maximum power consumed by the data center.

12. The power management system as recited in claim 1 wherein the secondary group of power consumers are cryptocurrency miners and the monitoring and control system is configured to, in a first condition, direct the power switching system to cause the second power source to power the cryptocurrency miners and to cause the first power source to power the data center.

13. The power management system as recited in claim 12 further comprising a power switching system configured to supply electricity to the first computing units from the first power source or the second power source,
wherein the monitoring and control system is configured to, in a second condition, direct the power switching system to electrically decouple the second power source from the cryptocurrency miners, to electrically decouple the first power source from the data center, and to direct the second power source to power the data center.

14. The power management system as recited in claim 13 wherein the monitoring and control system is configured to, in a third condition, direct the power switching system to electrically decouple the second power source from the cryptocurrency miners, to electrically decouple the first power source from the data center, and to direct the second power source to power the data center and to provide power to the first power source.

15. The power management system as recited in claim 1 further comprising a power switching system configured to supply electricity to the first computing units from the first power source or the second power source,
wherein the secondary group of power consumers are cryptocurrency miners and the monitoring and control system is configured to direct the power switching system to maximize a total profit equal to a net profit of operating the data center plus a net profit of operating the cryptocurrency miners, and is configured to direct the power switching system to shut down the cryptocurrency miners and to power the data center by the second power source when doing so maximizes the total profit.

16. The power management system as recited in claim 1, wherein the first computing units each have a maximum power consumption, the first computing units together having a rated power consumption defined by a cumulative sum of maximum power consumptions of the first computing units,
the first power source being power generation module configured to consume natural gas and continuously generate an electrical output to power the first computing units and the second computing units;
the power management system further comprising:
a power distribution system configured to distribute the electrical output generated by the first and second power sources to the first computing units and the second computing units; and
a carbon capture system configured to receive exhaust gas from the first and second power sources, capture carbon from the exhaust gas and release oxygen from the exhaust gas into the atmosphere;
the monitoring and control system being configured to:
receive metrics of the first and second power sources;
receive real-time power consumption metrics for the first computing units, the first computing units configured for consuming variable power during operation; and
output a control signal to vary a power consumption of the second computing units based on a difference between the real-time power consumption metrics for the first computing units and the rated power consumption of the first computing units.

17. The power management system as recited in claim 16 wherein the power distribution system includes a common electrical bus syncing outputs of the first and second power sources to provide a common electrical output,
the monitoring and control system configured to:
control power consumed by the set of second computing units to achieve a predetermined electrical consumption of the common electrical output, the predetermined electrical consumption being a minimum threshold required by the carbon capture system.

18. The power management system as recited in claim 16 wherein the second computing units are cryptocurrency miners, the cryptocurrency miners each having a respective rated power consumption defining a maximum amount of power the cryptocurrency miner is designed to consume,
the varying of the power consumption of the set of second computing units including increasing the power consumption of at least some of the cryptocurrency miners above the respective rated power consumption.

19. The power management system as recited in claim 16 wherein the second computing units are cryptocurrency miners, the second computing units including a subset of first cryptocurrency miners and a subset of second cryptocurrency miners,
the varying of the power consumption of the set of second computing units including turning on and off the subset of second cryptocurrency miners.

20. The power management system as recited in claim 19 wherein the monitoring and control system is configured to:
refrain from varying the power consumption of the subset of first cryptocurrency miners while turning on and off the subset of second cryptocurrency miners.

21. The power management system as recited in claim 19 wherein the first cryptocurrency miners have a higher average hashrate per unit of energy consumed than the second cryptocurrency miners.

22. The power management system as recited in claim 16 further comprising a heating, ventilation and air conditioning (HVAC) system configured to consume the electrical output generated by the first power source and/or the second power source,
the monitoring and control system configured to:
receive metrics of the HVAC system; and
output the control signal to vary the power consumption of the set of second computing units based on:
the difference between the real-time power consumption metrics for the set of first computing units and the rated power consumption of the set of first computing units; and
real-time power consumption metrics for the HVAC system.

23. A method of dynamically controlling a supply of power to a power consumption system powered by a power production system comprising the following steps:
measuring and/or receiving metrics of the power production system while powering the power consumption system,
the power consumption system including a plurality of computing units including at least a set of first computing units and a set of second computing units, the first computing units in communication with a network for providing cloud services to remote client computers, the first computing units having an energy priority over the second computing units,
the power production system including power sources including a first power source and a second power source, the second power source including a power generation module configured to consume natural gas and continuously generate an electrical output sufficient to alternatively power the plurality of first computing units and the second computing units;
determining, from the metrics of the power production system, an operational status and/or an operational cost of each of the power sources; and
decreasing a power consumption of the second computing units and powering the set of first computing units by the second power source based on the operational status and/or the operational cost of each of the power sources.

24. A method of controlling a power consumption of a power consumption system powered by a power production system comprising the following steps:
(a) measuring and/or receiving metrics of the power production system and metrics of a power consumption system, the power consumption system including a plurality of computing units including at least a set of first computing units and a set of second computing units, the first computing units in communication with a network for providing cloud services to remote client computers, the first computing units having an energy priority over the second computing units, the first computing units each having a maximum power consumption, the set of first computing units together having a rated power consumption defined by a cumulative sum of the maximum power consumptions of the first computing units;
(b) determining a target power production framework that includes a target power delta for each of a plurality of devices associated with the power production system, the target power deltas being based on the metrics of power production system;
(c) determining an optimal power consumption distribution model for distributing the target power deltas of the target power production framework to the power consumption system based on the target power production framework and the metrics of power consumption system, the optimal power consumption distribution model taking into account a varying power consumption of the first computing units to vary a power consumption of the second computing units;
(d) altering a power state of the second computing units to achieve the optimal power consumption distribution model; and
(e) periodically repeating (a) to (d) to update the power state of the second computing units based on changes of the metrics of the power production system and changes of metrics of the power consumption system.

25. The method as recited in claim 24 wherein the second computing units are cryptocurrency miners, the cryptocurrency miners each having a respective rated power consumption defining a maximum amount of power the cryptocurrency miner is designed to consume,
the altering a power state of the second computing units including increasing the power consumption of at least some of the cryptocurrency miners above the respective rated power consumption.

26. The method as recited in claim 24 wherein the second computing units are cryptocurrency miners, the second computing units including a subset of first cryptocurrency miners and a subset of second cryptocurrency miners,
the altering a power state of the second computing units including turning on and off the subset of second cryptocurrency miners.

27. The method as recited in claim 24 wherein the determining an optimal power consumption distribution model includes distributing the target power deltas of the target power production framework to the power consumption system to achieve a power production of the power production system above a predetermined threshold.

28. The method as recited in claim 27 wherein the power production system includes a power generation module configured to consume natural gas and continuously generate an electrical output sufficient to alternatively power the plurality of first computing units and the second computing units
the predetermined threshold being a function of a cost of operating a carbon capture system configured to receive exhaust gas from the electrical power generation system, capture carbon from the exhaust gas and release oxygen from the exhaust gas into the atmosphere.

29. The method as recited in claim 24 wherein the determining an optimal power consumption distribution model includes distributing the target power deltas of the target power production framework to the power consumption system to maximize a power production of the power production system.

30. A method for powering a data center including a plurality of computing units and a cryptocurrency mining system including a plurality of cryptocurrency miners, the method comprising:
powering the data center by power generated from one or more primary power sources, the primary power sources including a renewable energy source and an electricity grid;
powering the cryptocurrency mining system by an electrical power generation system comprising one or more power generation modules configured to consume natural gas and continuously generate an electrical output; and
upon determining that the power generated from the one or more primary power sources costs a price exceeding a predetermined price threshold, electrically decoupling the electrical power generation system from the cryptocurrency miners and electrically decoupling the one or more primary power sources from the data center, and powering the data center by the electrical power generation system.

31. A method for powering a data center including a plurality of computing units and a cryptocurrency mining system including a plurality of cryptocurrency miners, the method comprising:
powering the data center by power generated from one or more primary power sources, the primary power sources including a renewable energy source and an electricity grid;
powering the cryptocurrency mining system by an electrical power generation system comprising one or more power generation modules configured to consume natural gas and continuously generate an electrical output; and
upon determining that the power generated from the one or more primary power sources costs a price exceeding a predetermined price threshold, electrically decoupling the electrical power generation system from the cryptocurrency miners and electrically decoupling the one or more primary power sources from the data center, and powering the data center by the electrical power generation system and selling excess power generated by the electrical power generation system to the electrical grid.
